(19) United States
(12) Patent Application Publication
(10) Pub. No.: US 2007/0153639 A1
(43) Pub. Date: Jul. 5, 2007

(54) Flexible band with clip-on watch

(76) Inventors: Ronald Lafever, Laguna Beach, CA (US); William C. Green, Charlotte, NC (US); Guy Johnson, Irvine, CA (US); Jon Christopher Lake, Sunnyvale, CA (US); Hiroshi Ono, Via Buozzi Bruno (IT); Davy Kho, Paris (FR)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/430,589

(22) Filed: Jun. 9, 2006

Related U.S. Application Data
(63) Continuation-in-part of application No. 11/293,472, filed on Dec. 2, 2005.

(51) Int. Cl. G04B 37/00

(52) U.S. Cl. 368/282

(57) ABSTRACT

A flexible band with clip-on watch module includes a band, a watch movement, a display, a surrounding case and an attachment mechanism. The attachment mechanism has several embodiments. These include a channel beneath the case comprised of two pair of opposed prongs; an elastic member passed beneath the band and the case and secured to ridges on the top surface of the case; an underband platform suspended from the case with retaining members at a side edge; a hingedly attached retaining clip that encloses the band and snaps onto a side of the case; one or more lateral slots in a side edge of the case into which the band is inserted; and a curved support platform under the watch module with retaining notches at either end for retention of a folded and flattened band. The case, recess, channel and attachment mechanism may be curved to better fit the wrist.

### RELATED APPLICATION

The present application is a continuation-in-part of U.S. application Ser. No. 11/293,472, filed Dec. 2, 2005 and currently pending.

### FIELD OF INVENTION

The invention pertains to watches. More particularly, the invention relates to modular watches designed to attach to continuous flexible bands.

### BACKGROUND OF THE INVENTION

With seven Tour de France victories, the story of Lance Armstrong and his battle with cancer has become a popular cause. Those supporting this cause do so by purchasing and wearing yellow plastic wrist bracelets. A charitable donation is made as a portion of the purchase price. Tens of millions of these bracelets have been sold and bracelets of other colors have been sold in association with other charitable causes. The present invention relates to a watch module designed to attach to these plastic wrist bracelets. Many designs have been developed for attaching a watch to a watch band, however, there are very few designs for attachment of a watch to a continuous flexible band, i.e., one without a closure means.

U.S. Pat. No. 6,130,861, issued to Della Felice, discloses a watch case with a retaining means which is hinged at one end to the case by a hinge extending transversely with respect to the line of the strap, at a limited distance from the rear surface of the case in order to allow the strap to be passed through. The retaining means can be closed against the case in order to grip the strap (which is thus easy to replace) and is positionable at a limited angle with respect to the case, such that it can be stood on a surface like a little table-top clock.

U.S. Pat. No. 5,491,984, issued to Loch is directed to a ring-shaped member for hand wear. The ring-shaped member is to be worn on the hand of the individual and is band type structure having first and second ends for closure. In one embodiment of the invention a time piece may be attached to the ring shaped member.

U.S. Patent Publication No. 2005/0022554, by Davidson et al. discloses a bracelet with interchangeable adornments for storing medications, hygiene products, or food. The bracelet with interchangeable adornments has a strap and a container. The container attaches to the strap via a fastening means. Furthermore, the container has a base and a lid. The lid is coupled to the base via a movable member. The movable member prevents the lid from detaching from the base while enabling the lid to open and close. The base is hollow and is generally geometric in shape or generally represents an object that is flower-like, person-like, or animal-like.

U.S. Pat. No. 2,541,432, issued to Muehlbauer describes a compass attachment for wristwatch straps and bands. The compass is attached to the band by means of a clip.

U.S. Pat. No. 3,739,740, issued to Fromer is directed to a wrist mounted pill box. A watch is attached to a band by means of flexible extensions which are secured to a lower container portion so that they can be bent under the wrist band or strap.

U.S. Pat. No. 4,326,280, issued to Perry, Jr. describes a device for convenient mounting of a wrist watch on a belt. The watch is mounted within a case having a belt bracket and a hinged protective cover. The watch is hingedly mounted on one of its conventional strap pins to the inside of the protective cover. Both hinged mountings are spring biased to urge the protective cover and watch to a normal closed position. The other conventional strap pin of the watch retains a strap which hangs freely from the case, to provide a convenient handle to open the case and pull the watch into view.

U.S. Pat. No. 4,862,436, issued to Harilela describes a watch and strap combination in which the strap is essentially constituted by an elongate rectangular strip of paper material of weight between 150 and 350 g/m.sup.2, carrying printed matter under an optional PVC lamination. Means for fastening together the strap ends may include a double-sided adhesive patch or a touch-and-close fastener.

U.S. Pat. No. 3,797,148, issued to Ivengsberg et al. is directed to an arrangement in or relating to a year calendar. The calendar is attached to a band by means of securing clips which are bent inwardly at the lower surface of the strap.

U.S. Pat. No. 4,542,630, issued to Nanasi discloses a flexible, elongated band that has a removable ornament thereon that can be intentionally removed from the band but cannot be accidentally removed.

It is an objective of the present invention to provide a mechanism for attaching a watch to a flexible continuous wrist band. It is a further objective to provide a mechanism that will provide a secure attachment while permitting relatively easy removal of the watch from the band. It is a still further objective of the invention to provide an attachment mechanism that can be used with watches of different sizes. Finally, it is an objective to provide a watch and band combination based upon flexible, continuous bands that is simple and inexpensive to produce and durable in nature.

While some of the objectives of the present invention are disclosed in the prior art, none of the inventions found include all of the requirements identified.

### SUMMARY OF THE INVENTION

The present invention addresses all of the deficiencies of prior art clip-on watch inventions and satisfies all of the objectives described above.

(1) A flexible band with clip-on watch can be fabricated from the following components. At least one flexible, continuous band is provided. The band has a first predetermined width and a first predetermined thickness, is formed of resilient material and is sized and shaped to fit stretchably over a wearer's hand and loosely about the wearer's wrist. A watch module is provided. The watch module includes a time-keeping movement, a display, a surrounding case, and an attachment mechanism. The case has an upper surface and a lower surface. The attachment mechanism removably joins the watch module to the band.

(2) In a variant of the invention, the attachment mechanism further includes first and second retaining clips. Each of the clips extends outwardly from the surrounding case along a diameter of the watch module in opposite directions. Each of the clips has a channel through it. The channel has an upper wall, a lower wall and is sized and shaped to fit slidably about the band. The lower wall includes first and second opposing prongs. The prongs are located at right angles to the diameter and extend inwardly from outer edges of the clips toward each other. The prongs are spaced apart sufficiently to permit an edge of the band to pass between them. When the edge of the band is passed between each of the sets of prongs and turned to lie flat against the lower surface of the surrounding case, the band will be removably attached to the watch module.

(3) In another variant, the watch module further includes a bottom plate. The bottom plate is attached to the lower surface of the surrounding case and forms the upper wall of the channel. The lower wall includes the first and second opposing prongs descending from side edges of the bottom plate.

(4) In still another variant, the bottom plate is curved to permit the watch module to fit more closely against the wrist of the wearer.

(5) In yet another variant, the upper wall of the channel is recessed into the lower surface of the surrounding case, thereby permitting the band to fit more closely against the wrist of the wearer.

(6) In a further variant, the watch module includes an analog watch movement.

(7) In still a further variant, the watch module includes a digital watch movement.

(8) In yet a further variant, the watch module is waterproof.

(9) In a variant of the invention, the attachment mechanism further includes at least one first side wall. The first side wall is attached at a right angle to the lower surface of the surrounding case and descends from it for a first predetermined distance. At least one underband plate is provided. The plate is attached at a right angle at a proximate edge to a lower edge of the first side wall. The plate has a width at least equal to the first predetermined width and is spaced from the lower surface by at least the first predetermined thickness. At least one second side wall is provided. The second side wall is attached at a right angle at a distal edge of the underband plate and ascends toward the lower surface for at least the first predetermined distance. At least one retaining tab is provided. The retaining tab is attached at a right angle at an upper edge of the second side wall and extends inwardly over the underband plate for a second predetermined distance. When the band is inserted between the lower surface of the surrounding case and the underband plate it will be located against the first side wall and when the band is then pushed under the retaining tab it will be located between the first side wall and the second side wall, thereby removably attaching the watch module to the band.

(10) In another variant, the underband plate is curved to permit the watch module to fit more closely against the wrist of the wearer.

(11) In still another variant, the lower surface of the surrounding case is recessed, thereby providing a space for the band and permitting the watch module to fit more closely against the wrist of the wearer.

(12) In yet another variant, the attachment mechanism further includes first and second retaining means. The retaining means extend upwardly from the upper surface of the surrounding case. A continuous loop is provided. The loop is formed of resilient material and is sized and shaped to extend from an inner edge of the first retaining means, beneath the lower surface of the watch module and the continuous band, and over an inner edge of the second retaining means, thereby removably attaching the watch module to the band.

(13) In a further variant, the attachment mechanism further includes a recess. The recess is located in the lower surface of the surrounding case, is sized and shaped to fit frictionally about the band and permits the watch module to fit more closely against the wrist of the wearer.

(14) In still a further variant, the lower surface of the surrounding case and the recess are curved, thereby permitting the watch to fit more closely against the wrist of the wearer.

(15) In yet a further variant, the retaining means further includes first and second ridges. The ridges are sized and shaped to retain the continuous loop.

(16) In another variant of the invention, the attachment mechanism further includes at least one side notch. The side notch extends downwardly from ends of the first and second ridges along side edges of the surrounding case. The notches make attachment of the continuous loop more compact.

(17) In still another variant, the attachment mechanism further includes an attachment bracket. The bracket is formed of resilient material, hingedly attached at a first end adjacent a first side of the lower surface of the surrounding case and removably attached at a second end adjacent an opposite second side of the lower surface. The bracket is spaced downwardly from the lower surface by a distance slightly less than the first predetermined thickness. The bracket bears frictionally against the band when the second end is attached adjacent the opposite second side of the lower surface. When the second end of the bracket is detached from adjacent the opposite second side, the watch module may be removed from the band.

(18) In yet another variant, the first end of the bracket is hingedly attached at a first point on a first side edge of the surrounding case. The bracket descends from the first point below the lower surface of the case, extends across the lower surface and ascends to a second point on an opposite second side edge of the case. The second end of the bracket is removably attached to the second side edge adjacent the second point.

(19) In a further variant, the attachment mechanism further includes a recess. The recess is located in the lower surface of the surrounding case, is sized and shaped to fit frictionally about the band and permits the watch module to fit more closely against the wrist of the wearer.

(20) In still a further variant, the lower surface of the surrounding case and the recess are curved, thereby permitting the watch to fit more closely against the wrist of the wearer.

(21) In yet a further variant, the attachment mechanism further includes an elastic member. The member has a first predetermined cross section, is sized and shaped to fit elastically about a peripheral edge of the surrounding case, under the lower surface of the case, across the band and back over the peripheral edge. A circumferential groove is provided. The groove is located about the peripheral edge of the surrounding case and is sized and shaped to retain at least one cross section of the elastic member. When the elastic member is looped about the circumferential groove and passed under the lower surface of the surrounding case, under the band and back up and over the case and stretched over the groove, the watch module will be removably attached to the band.

(22) In another variant of the invention, the attachment mechanism further includes a recess. The recess is located in the lower surface of the surrounding case, is sized and shaped to fit frictionally about the band and permits the watch module to fit more closely against the wrist of the wearer.

(23) In still another variant, the lower surface of the surrounding case and the recess are curved, thereby permitting the watch to fit more closely against the wrist of the wearer.

(24) In yet another variant, the elastic member includes two circular portions. The circular portions are sized and shaped to fit elastically about the circumferential groove. The circular portions are joined at their peripheral edges by at least one straight member. The straight member is sized to extend elastically from the first circular portion, under the lower surface of the surrounding case, under the band and back to the peripheral edge of the second circular portion.

(25) In a further variant, the attachment mechanism further includes at least one slot. The slot extends from a front edge of the surrounding case to a rear edge of the case, has an opening at a side edge of the case and is sized and shaped to fit frictionally about the band. When the band is inserted into the slot, the watch module will be removably attached to the band.

(26) In still a further variant, the opening is slightly smaller than the first predetermined thickness. When the band is inserted into the slot, slight pressure will be required to force the band past the opening and into the slot, thereby securing the watch module to the band.

(27) In yet a further variant, the attachment mechanism further includes first and second parallel slots. The slots are located above the lower surface of the surrounding case. Each of the slots has an opening at an adjacent side edge of the case. Two bands are provided. Each of the bands is disposed in one of the first and second slots.

(28) In another variant of the invention, the lower surface of the surrounding case is curved, thereby permitting the watch to fit more closely against the wrist of the wearer.

(29) In still another variant, the attachment mechanism further includes a curved support platform. The platform has a first end and a second end. Each of the ends extends outwardly adjacent first and second side edges of the lower surface of the surrounding case, is curved to conform to the wrist of the wearer, and has a width at least equal to the first predetermined width. First and second attachment notches are provided. Each of the notches is located adjacent one of the first and second ends of the support platform and is sized and shaped to retain a folded loop of the flexible, continuous band. When a folded loop of the band is inserted into to each of the first and second attachment notches, the watch module will be removably attached to the folded band.

(30) In yet another variant, each of the attachment notches includes an aperture located adjacent each of the first and second ends of the support platform. A retaining member is provided. The retaining member extends from a proximal end attached to a lateral inside edge of the aperture toward an opposite lateral inside edge. A distal end of the retaining member is spaced from the opposite edge by at least the first predetermined thickness. When the folded loop of the flexible, continuous band is inserted into each of the apertures and about the retaining member, the watch module will be removably attached to the folded band.

(31) In a further variant, each of the attachment notches includes an opening. The opening extends from a first edge of the curved support platform toward a second opposite edge of the platform. The opening defines a retaining member disposed at a distal end of the support platform, the retaining member is spaced outwardly from the opening by at least the first predetermined thickness. When the folded loop of the flexible, continuous band is disposed through the opening and about each of the retaining members the watch module will be removably. attached to the folded band.

(32) In still a further variant of the invention, each of the retaining members is attached to the second edge of the support platform at an acute angle, thereby more securely attaching the watch module to the folded band.

(33) In yet a further variant, the attachment mechanism further includes an attachment bracket. The bracket is formed of resilient material, hingedly attached at a first end adjacent a first side of the lower surface of the surrounding case and removably attached at a second end adjacent an opposite second side of the upper surface of the case. The bracket is spaced downwardly from the lower surface by a distance slightly less than the first predetermined thickness. The bracket bears frictionally against the band when the second end is attached adjacent the opposite second side of the upper surface. When the second end of the bracket is detached from adjacent the opposite second side, the watch module may be removed from the band.

(34) In another variant, the first end of the bracket is hingedly attached at a first point on the first side edge of the surrounding case. The bracket descends from the first point below the lower surface of the case, extends across the lower surface and ascends to a second point on an opposite second side of the upper surface of the case. The second end of the bracket is removably attached to the upper surface adjacent the second point.

(35) In still another variant, the attachment mechanism further includes a recess. The recess is located in the lower surface of the surrounding case, is sized and shaped to fit frictionally about the band and permits the watch module to fit more closely against the wrist of the wearer.

(36) In a further variant, the lower surface of the surrounding case and the recess are curved, thereby permitting the watch to fit more closely against the wrist of the wearer.

(37) In another variant of the invention, the attachment mechanism includes an underband fastener. The fastener is cylindrical, has a diameter less than an outer horizontal dimension of the watch module, a horizontal slot at least as wide as the first predetermined width and approximately as deep as the first predetermined thickness and a surrounding external thread. The lower surface of the surrounding case has a recess. The recess is sized, shaped and matingly threaded to receive the underband fastener. The flexible, continuous band is located within the horizontal slot and the underband fastener is threaded into the recess and the watch module is removably attached to the band.

(38) In still another variant, the attachment mechanism includes a band retaining tray. The retaining tray has a horizontal slot at least as wide as the first predetermined width and approximately as deep as the first predetermined thickness, first and second side edges adjacent the slot and a locking tab extending upwardly from the first side edge. The retaining tray is hingedly attached at the second side edge to the surrounding case at a side edge of the case. A mating locking recess is provided. The locking recess is located at an opposite side edge of the surrounding case and is sized and shaped to removably attach the band retaining tray to the surrounding case at the first side edge. The flexible, continuous band is located within the horizontal slot, the locking tab engages the mating locking recess and the watch module is removably attached to the band.

(39) In yet another variant, the attachment mechanism includes a retaining disk. The retaining disk has a second predetermined thickness, a horizontal slot at least as wide as the first predetermined width and approximately as deep as the first predetermined thickness, at least two curved keyhole-shaped apertures located adjacent the horizontal slot. The keyhole-shaped aperture has a wide portion and a narrow portion. At least two mating securing protrusions are provided. The protrusions have a shaft portion extending downwardly from the lower surface of the surrounding case and a head portion located at a lower end of the shaft portion. The shaft portion is slightly longer than the second predetermined thickness, and is sized and shaped to fit slidably within the narrow portion of the keyhole-shaped aperture. The head portion is sized and shaped to fit slidably within the wide portion of the keyhole-shaped aperture. The flexible, continuous band is located within the horizontal slot, the head portion of the mating securing protrusion passes through the wide portion of the keyhole-shaped aperture, the watch module is twisted with respect to the retaining disk and the shaft portion entersg the narrow portion of the keyhole-shaped aperture, thereby removably securing the flexible band between the retaining disk and the lower surface of the surrounding case.

(40) In still another variant, the attachment mechanism includes at least one detent. The detent is located on either of the lower surface of the surrounding case and an upper surface of the retaining disk. At least one mating detent button is provided. The mating detent button extends from the surrounding case or the upper surface of the retaining disk and removably engages the at least one detent to deter rotation of the retaining disk with respect to the surrounding case, thereby more securely attaching the watch module to the flexible band.

(41) In yet another variant, the attachment mechanism includes a sliding retainer plate. The retainer plate has a horizontal slot at least as wide as the first predetermined width and approximately as deep as the first predetermined thickness. It is rotatably attached to the lower surface of the surrounding case at a point adjacent the horizontal slot. At least one detent is provided. The detent is located on either of the lower surface of the surrounding case and an upper surface of the retainer plate. At least one mating detent button is provided. The mating detent button extends from the surrounding case or the upper surface of the retainer plate and removably engages the at least one detent to deter rotation of the retainer plate with respect to the surrounding case, thereby removably attaching the watch module to the flexible band.

(42) In a further variant, the attachment mechanism includes a retaining platform. The retaining platform has a horizontal slot at least as wide as the first predetermined width and approximately as deep as the first predetermined thickness. The platform has first and second side edges. The side edges are parallel to and extend outwardly from the horizontal slot, and have a third predetermined thickness. A receiving channel is provided. The receiving channel is located in the lower surface of the surrounding case, has first and second parallel receiving notches. The notches are sized and shaped to fit slidably over the first and second side edges of the retaining platform, thereby removably attaching the watch module to the flexible band.

(43) In still a further variant, the attachment mechanism includes at least one detent. The detent is located on either of the first and second side edges of the retaining platform and inner surfaces of the first and second parallel receiving notches. At least one mating detent button is provided. The mating detent button extends from either of first and second side edges of the retaining platform and inner surfaces of the first and second parallel receiving notches. The mating detent button removably engages the at least one detent to deter sliding of the retaining platform with respect to the surrounding case, thereby more securely attaching the watch module to the flexible band.

(44) In yet a further variant, the attachment mechanism includes a horizontal slot at least as wide as the first predetermined width and deeper than the first predetermined thickness. The slot has an upper surface and substantially vertical first and second side walls. The horizontal slot is located in the lower surface of the surrounding case. At least one securing aperture is provided. The securing aperture penetrates the surrounding case and the first vertical side wall at a point spaced from the upper surface by approximately the first predetermined thickness. At least one mating receiving recess is provided. The receiving recess is located in the opposite second vertical side wall in alignment with the securing aperture. At least one retaining rod is provided. The retaining rod is sized and shaped to fit frictionally through the securing aperture and into the receiving recess. The flexible band is located in the horizontal slot, the retaining rod is inserted into the securing aperture, under the flexible band and into the mating receiving recess, thereby removably attaching the watch module to the flexible band.

(45) In another variant of the invention, the attachment mechanism includes a locking lip. The locking lip is located in a side edge of the surrounding case slightly below an upper edge of the securing aperture. The locking lip bears against the retaining rod as the rod is inserted into the securing aperture and thereby securing an end of the retaining rod and preventing the rod from moving backward out of the aperture and thus removably attaching the watch module to the flexible band.

(46) In still another variant, the attachment mechanism includes an underband tray. The tray has first and second side edges, a horizontal slot at least as wide as the first predetermined width and at least as deep as the first predetermined thickness located between the side edges. The tray has either of a magnet and ferromagnetic material located between the first side edge and the slot. The tray is hingedly attached adjacent the second side edge to the surrounding case. The surrounding case has either of a magnet and ferromagnetic material located in the lower surface to removably engage either of the magnet and the ferromagnetic material located in the tray, thereby removably attaching the watch module to the flexible band.

(47) In yet another variant, the attachment mechanism includes a horizontal slot at least as wide as the first predetermined width and substantially as deep as the first predetermined thickness, the horizontal slot is located in the lower surface of the surrounding case. A spring clip is provided. The spring clip has a first end and a second end and is pivotally mounted at the first end to the lower surface of the surrounding case. The surrounding case has a retaining recess. The recess is located in the lower surface adjacent to the horizontal slot and sized and shaped to removably receive the second end of the spring clip. The horizontal slot receives the flexible band, the spring clip slides pivotally over the band and removably engages the retaining recess, thererby removably attaching the watch module to the flexible band.

(48) In a further variant, the attachment mechanism includes a horizontal slot at least as wide as the first predetermined width and substantially as deep as the first predetermined thickness, the horizontal slot is located in the lower surface of the surrounding case. At least one threaded hole is provided. The threaded hole is located in an upper surface of the horizontal slot. A screw is provided. The screw has a mating thread for removably attaching to the threaded hole and a point for piercing the flexible band. The screw penetrates the flexible band and removably engages the threaded hole, thereby removably attaching the watch module to the flexible band.

(49) In still a further variant, the attachment mechanism includes at least one retaining arm. The retaining arm is formed of malleable material and descends from the surrounding case for a distance equal to at least a portion of the first predetermined width. The retaining arm is bendable over the flexible band and removably attaches the watch module to the flexible band.

(50) In yet a further variant, the attachment mechanism includes a horizontal slot at least as wide as the first predetermined width and substantially as deep as the first predetermined thickness. The horizontal slot is located in the lower surface of the surrounding case.

(51) In another variant of the invention, the attachment mechanism includes a fixed retaining arm. The fixed arm descends from a side edge of the surrounding case and has a first inturned lip. The first lip is spaced from the lower surface of surrounding case by the first predetermined thickness. A sliding retaining arm is provided. The sliding arm descends from an opposite side edge of the surrounding case, has an upper slide member, and a second inturned lip. The second lip is spaced from the lower surface of surrounding case by the first predetermined thickness. The upper slide member has a protrusion on either of an upper surface and a lower surface of the member and fits slidably within a slot in the surrounding case adjacent the lower surface. The slot has a detent on an interior wall of the slot. The detent removably receives the protrusion. The first and second inturned lips removably engage the flexible band, the protrusion on the slide member removably engages the detent and thus removably attaches the watch module to the flexible band.

(52) In still another variant, the attachment mechanism includes a receiving tray. The receiving tray has a horizontal slot at least as wide as the first predetermined width and approximately as deep as the first predetermined thickness, an upper surface, a lower surface and first and second side edges, the side edges are parallel to and extend outwardly from the horizontal slot. First and second attachment notches are provided. The notches are located at the first and second side edges, respectively, and extend from the upper surface to the lower surface of the tray and inwardly from the side edges. First and second relief cuts are provided. The relief cuts are located at the lower surface of the tray and extend inwardly from the first and second attachment notches. First and second snap fingers are provided. The snap fingers extend downwardly from the surrounding case and have a securing ledge extending inwardly from lower ends of the fingers. The first and second snap fingers are sized and shaped to fit slidably within the attachment notches and the securing ledges are sized and shaped to fit removably into the first and second relief cuts. The flexible band is located in the horizontal slot in the receiving tray. The tray is removably attached to the snap fingers and removably attaches the watch module to the flexible band.

(53) In yet another variant, the attachment mechanism includes a horizontal slot at least as wide as the first predetermined width and deeper than the first predetermined thickness. The horizontal slot is located in the lower surface of the surrounding case. A retaining slot is provided. The retaining slot is located about a perimeter of the surrounding case. The slot has an upper edge and a lower edge and is spaced upwardly from the lower surface of the surrounding case. The upper edge is spaced downwardly from an upper surface of the horizontal slot by approximately the first predetermined thickness. An elastic member is provided. The elastic member is sized and shaped to fit closely between the upper edge and the lower edge of the retaining slot. The flexible band is located within the horizontal slot. The elastic member is located within the retaining slot and removably attachesthe watch module to the flexible band.

(54) In still another variant, the attachment mechanism includes a horizontal slot at least as wide as the first predetermined width and substantially as deep as the first predetermined thickness. The horizontal slot is located in the lower surface of the surrounding case. The slot has first and second parallel side edges. First and second retaining brackets are provided. The brackets extend outwardly from the first and second parallel side edges in opposite directions. Each of the retaining brackets terminates in a pair of pin fastening notches. The notches are located on either side of the horizontal slot. First and second securing pins are provided. Each of the pins has a shaft sized and shaped to fit frictionally within the pin fastening notches and first and second end caps. The ends caps are larger than the notches. The flexible band is located within the horizontal slot, the securing pins are located within the pin fastening notches and removably attach the watch module to the flexible band.

(55) In a further variant, the attachment mechanism includes a horizontal slot at least as wide as the first predetermined width and substantially as deep as the first predetermined thickness. The horizontal slot is located in the lower surface of the surrounding case. The slot has first and second parallel side edges. First and second L-shaped clips are provided. Each of the L-shaped clips has a first end, a second end, first and second side edges and is hingedly attached to opposite side edges of the surrounding case. The clips are sized and shaped to constrain the flexible band in the horizontal slot when folded below the case. Each of the clips has a raised retaining button. Each of the side edges of the surrounding case has a receiving detent. Each of the detents is sized and shaped to removably retain one of the retaining buttons. The flexible band is located within the horizontal slot, the L-shaped clips are pivoted downwardly to constrain the band within the slot and the retaining buttons engage the receiving detents to removably attach the watch module to the band.

(56) In still a further variant, the attachment mechanism includes first and second retaining brackets. Each of the retaining brackets extends outwardly from the surrounding case in opposite directions parallel to the flexible band. Each of the retaining brackets has first and second parallel side plates, the side plates are spaced apart by at least the first predetermined width and terminate in an end bar connecting the side plates. The surrounding case, each pair of side plates and each end bar define an aperture at least twice as long as the first predetermined thickness. First and second securing pins are provided. Each of the pins has a shaft at least as long as the first predetermined width and first and second end caps. The ends caps are larger than the shaft. The flexible band is located beneath the surrounding case and has loops extending upwardly through the apertures. The securing pins are located within the loops and the end caps secure the pins to the band, removably attaching the watch module to the band.

(57) In another variant of the invention, the surrounding case includes a horizontal slot. The slot is at least as wide as the first predetermined width and substantially as deep as the first predetermined thickness. The horizontal slot is located in the lower surface of the surrounding case, the slot has first and second parallel side edges.

(58) In still another variant, the attachment mechanism includes first and second retaining ledges. Each of the retaining ledges extends outwardly from the surrounding case in opposite directions parallel to the flexible band. A retaining clip is provided. The clip is formed of resilient material, is sized and shaped to fit beneath the surrounding case and flexible band and has curved ends. The ends urge loops of the flexible band over the retaining ledges and inwardly toward the surrounding case. The curved ends extend upwardly past the ledges. The retaining clip removably attaches the watch module to the flexible band.

(59) In yet another variant, the surrounding case includes a horizontal slot. The slot is at least as wide as the first predetermined width and substantially as deep as the first predetermined thickness. The horizontal slot is located in the lower surface of the surrounding case. The slot has first and second parallel side edges.

(60) In a further variant, the attachment mechanism includes an attachment sleeve. The sleeve has a planar upper portion and a planar lower portion. Each of the portions has an upper surface, a lower surface, first and second side edges, upper edges and lower edges. The upper portion is attached to the lower surface of the surrounding case and hingedly attached at the first side edge to the first side edge of the lower portion. At least one attachment means is provided. The attachment means removably secures the upper portion to the lower portion at the second side edges. The flexible band is removably secured between the upper portion and the lower portion, thereby removably attaching the watch module to the flexible band.

(61) In still a further variant, the attachment means is selected from the group consisting of snap, button, hook and loop fastener and slot and turn button fastener.

(62) In yet a further variant, the attachment mechanism includes first and second receiving bars. Each of the bars is attached to opposite lower edges of the surrounding case and spaced outwardly from the case by a pair of support brackets. A securing strap is provided. The strap is formed of flexible material, has a first end, a second end, an upper surface and a lower surface. The upper surface has a hooking attachment means adjacent the first end. The lower surface has a loop attachment means adjacent the second end. The flexible band is located beneath the lower surface of the surrounding case. The securing strap is looped over the receiving bars and under the flexible band. The second end is folded over the first end, the hooking attachment means removably engages the loop attachment means and removably secures the watch module to the flexible band.

(63) In still a further variant of the invention, the surrounding case includes a horizontal slot. The slot is at least as wide as the first predetermined width and substantially as deep as the first predetermined thickness. The horizontal slot is located in the lower surface of the surrounding case. The slot has first and second parallel side edges.

(64) In a final variant, a subband fastener is provided. The fastener is formed of resilient material, cylindrical, has a diameter less than an outer horizontal dimension of the watch module. The fastener has a horizontal slot at least as wide as the first predetermined width, approximately as deep as the first predetermined thickness and a peripheral lip. The lip extends on either side of the slot. The lower surface of the surrounding case has a recess. The recess is sized, and shaped to receive the peripheral lip of the subband fastener. The flexible, continuous band is located within the horizontal slot and the subband fastener is fit frictionally into the recess. The watch module will be removably attached to the band.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a first embodiment of the invention illustrating an analog watch module with prong-type attachment mechanism;

FIG. 2 is a side elevational view of the FIG. 1 embodiment illustrating passage of the continuous band through the attachment mechanism;

FIG. 2A is a side elevational view of the FIG. 1 embodiment illustrating a surrounding case having a curved lower surface;

FIG. 2B is a side elevational view of the FIG. 1 embodiment illustrating a surrounding case having a curved bottom plate;

FIG. 3 is a bottom view of the FIG. 1 embodiment illustrating the prong-type attachment mechanism;

FIG. 3A is a bottom view of the FIG. 1 embodiment illustrating a recessed channel in the lower surface of the surrounding case;

FIG. 4 is a perspective view of a second embodiment of the invention illustrating a digital watch movement and prong-type attachment mechanism;

FIG. 5 is a side elevational view of the FIG. 4 embodiment illustrating passage of the continuous band through the attachment mechanism;

FIG. 6 is a perspective view of the watch module of the FIG. 4 embodiment illustrating the prong-type attachment mechanism and a channel in the lower surface of the surrounding case;

FIG. 7 is a perspective view of a third embodiment of the invention illustrating an analog watch movement and elastic member-type attachment mechanism;

FIG. 8 is a top view of the FIG. 7 embodiment with a partial section illustrating attachment ridges on an upper surface of the surrounding case;

FIG. 9 is a side elevational view of the FIG. 7 embodiment illustrating a curved watch module and a recess the lower surface of the case;

FIG. 10 is a bottom view of the FIG. 7 embodiment illustrating a recess the lower surface of the case;

FIG. 11 is a perspective view of a fourth embodiment of the invention illustrating an analog watch movement and underband plate-type attachment mechanism;

FIG. 12 a side elevational view of the FIG. 11 embodiment illustrating a curved underband plate;

FIG. 13 is a top view of the FIG. 11 embodiment illustrating the underband plate and two retaining tabs;

FIG. 14 a side elevational view of the FIG. 11 embodiment illustrating a curved underband plate; and a recess in the lower surface of the watch module;

FIG. 15 is a perspective view of a larger version of the FIG. 11 embodiment illustrating a watch module having two underband plates and retaining tabs on each side of the surrounding case;

FIG. 16 a bottom view of the FIG. 15 embodiment illustrating the two underband plates;

FIG. 17 a side elevational view of the FIG. 15 embodiment illustrating a curved underband plate;

FIG. 18 is a perspective view of a fifth embodiment of the invention illustrating a hinged clip-type attachment mechanism in an open position;

FIG. 19 is a side elevational view of the FIG. 18 embodiment of the invention illustrating a hinged clip-type attachment mechanism pivoting at the side of the lower surface of the surrounding case and fastening on the upper surface of the case;

FIG. 19A is a side elevational view of the FIG. 18 embodiment of the invention illustrating a hinged clip-type attachment mechanism pivoting at the side of the surrounding case and fastening on the upper surface of the case;

FIG. 20 is a side elevational view of the FIG. 18 embodiment of the invention illustrating a hinged clip-type attachment mechanism pivoting at the side of the surrounding case and fastening on the side of the case;

FIG. 21 is a side elevational view of the FIG. 18 embodiment of the invention illustrating a hinged clip-type attachment mechanism pivoting at the side of the lower surface of the surrounding case and fastening at an opposite side of the lower surface of the case;

FIG. 22 is a perspective view of the FIG. 18 embodiment of the invention illustrating a channel in the curved lower surface of the surrounding case;

FIG. 23 is a perspective view of a sixth embodiment of the invention illustrating a watch module with a circumferential groove and elastic member attachment means;

FIG. 24 is a perspective view of the FIG. 23 embodiment of the invention illustrating the attachment of the elastic member;

FIG. 25 is a perspective view of the FIG. 23 embodiment of the invention illustrating the elastic member attached to the circumferential groove;

FIG. 26 is a perspective view of a seventh embodiment of the invention illustrating a dual band side opening attachment mechanism;

FIG. 27 is a perspective view of the watch module of the FIG. 26 embodiment of the invention illustrating the side openings of the attachment mechanism;

FIG. 28 is a perspective view of FIG. 26 embodiment of the invention illustrating a curved watch module;

FIG. 29 is a perspective view of the FIG. 26 embodiment of the invention illustrating a curved watch module for a single band;

FIG. 30 is a perspective view of an eighth embodiment of the invention illustrating a curved watch module with an attachment mechanism for a folded flexible band;

FIG. 31 is a partial detailed perspective view of the FIG. 30 embodiment of the invention illustrating attachment of the folded band to the watch module;

FIG. 32 is a perspective view of the FIG. 30 embodiment of the invention illustrating a variant in the band retaining mechanism;

FIG. 33 is a perspective view of the FIG. 30 embodiment of the invention illustrating another variant in the band retaining mechanism having an angled retaining member.

FIG. 34 is a perspective view of a ninth embodiment of the invention illustrating an underband fastener threaded into the watch module;

FIG. 35 is a perspective view of a tenth embodiment of the invention illustrating a band retaining tray that snaps into the watch module;

FIG. 36 is a perspective view of an eleventh embodiment of the invention illustrating a retaining disk with keyhole slots for attachment to pins attached to the watch module;

FIG. 37 is a perspective view from above of a twelfth embodiment of the invention illustrating a sliding retainer plate that is pivotally attached to the watch module;

FIG. 38 is a perspective view from below of the FIG. 37 embodiment of the invention illustrating a a sliding retainer plate that is pivotally attached to the watch module and retaining detent;

FIG. 39 is a perspective view of a thirteenth embodiment of the invention illustrating a retaining platform that fits matching slots on the watch module;

FIG. 40 is a perspective view of a fourteenth embodiment of the invention illustrating a horizontal slot with orthogonal apertures in the watch module and a mating retaining rod for attachment to the flexible band;

FIG. 41 is a perspective view of a fifteenth embodiment of the invention illustrating an underband tray that attaches magnetically to the watch module;

FIG. 42 is a perspective view of a sixteenth embodiment of the invention illustrating a horizontal slot in the watch module and a spring clip pivotally mounted to the module to retain the flexible band;

FIG. 43 is a perspective view of a seventeenth embodiment of the invention illustrating a horizontal slot in the watch module with a threaded hole in its center and a pointed screw that penetrates the band for attachment;

FIG. 44 is a perspective view of an eighteenth embodiment of the invention illustrating a horizontal slot in the watch module and malleable retaining arms that bend over the flexible band for attachment;

FIG. 45 is a perspective view from below of a nineteenth embodiment of the invention illustrating fixed and movable retaining arms attached to the watch module for retaining the flexible band;

FIG. 46 is a perspective view from above of the FIG. 45 embodiment of the invention illustrating closure of the movable, retaining arm;

FIG. 47 is a perspective view of a twentieth embodiment of the invention illustrating a receiving tray with a pair of notches that snaps into the watch module;

FIG. 48 is a perspective view of a twenty first embodiment of the invention illustrating a horizontal slot in the watch module for the flexible band and a circumferential groove for a retaining elastic member;

FIG. 49 is a perspective view of a twenty second embodiment of the invention illustrating a horizontal slot in the watch module with first and second retaining brackets at the ends of the slot and a pair of securing pins to attach the flexible band;

FIG. 50 is a perspective view of a twenty third embodiment of the invention illustrating a horizontal slot in the watch module and first and second movable L-shaped clips for retaining the flexible band;

FIG. 51 is a perspective view of a twenty fourth embodiment of the invention illustrating first and second retaining brackets attached to the watch module providing a pair of apertures for a loop of the flexible band; the band retained by a pair of securing pins;

FIG. 52 is a perspective view of a twenty fifth embodiment of the invention illustrating first and second retaining ledges attached to the watch module and a retaining clip holding the flexible band to the ledges of the module;

FIG. 53 is a perspective view of a twenty fifth embodiment of the invention illustrating an attachment sleeve attached to the watch module having fastening means for retaining the flexible band within the sleeve;

FIG. 54 is a perspective view of a twenty sixth embodiment of the invention illustrating first and second receiving bars attached to the watch module and a strap of flexible material for securing the flexible band to the watch module; and

FIG. 55 is a perspective view of a twenty seventh embodiment of the invention illustrating a subband fastener that has a surrounding protruding lip that snaps into a recess in the watch module.

### DETAILED DESCRIPTION OF THE PREFERRED EMBODIMENT

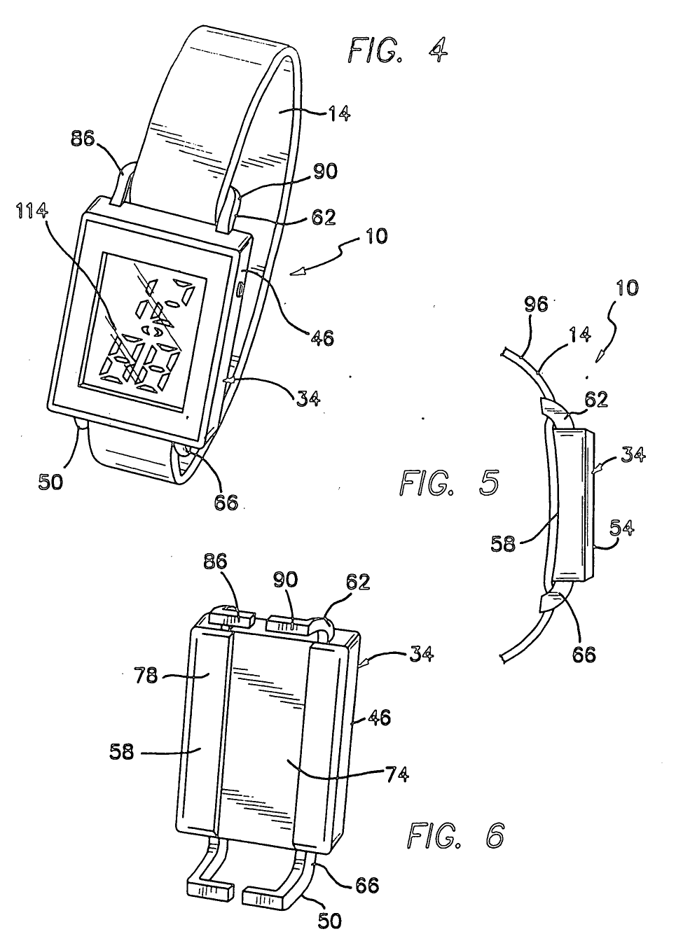

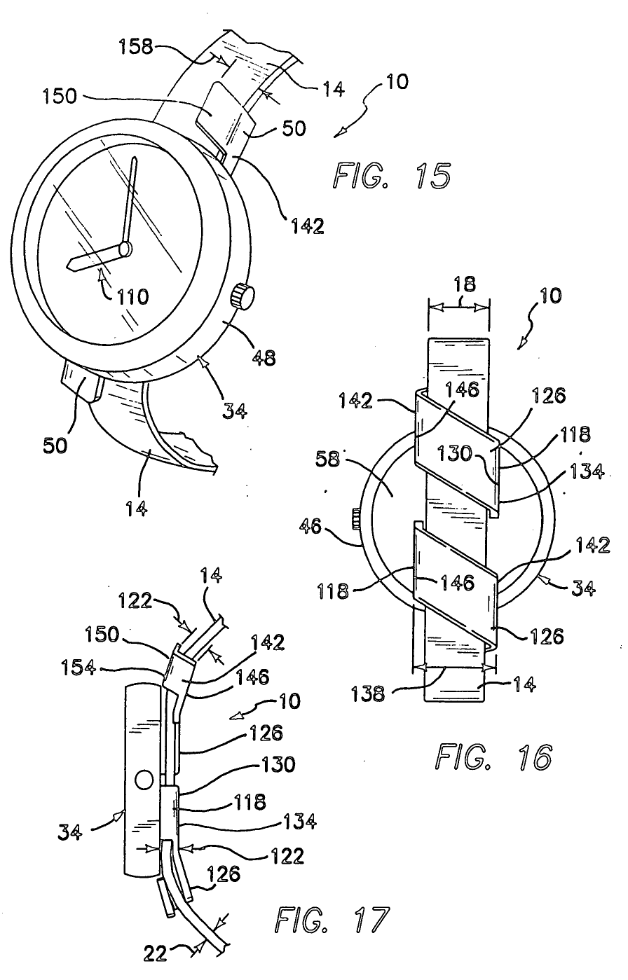

(1) A flexible band with clip-on watch 10, as illustrated in FIGS. 1-33, providing all of the desired features can be constructed from the following components. At least one flexible, continuous band 14 is provided. The band 14 has a first predetermined width 18 and a first predetermined thickness 22, is formed of resilient material and is sized and shaped to fit stretchably over a wearer's hand (not shown) and loosely about the wearer's wrist 30. A watch module 34 is provided. The watch module 34 includes a time-keeping movement 38, a display 42, a surrounding case 46, and an attachment mechanism 50. The case 46 has an upper surface 54 and a lower surface 58. The attachment mechanism 50 removably joins the watch module 34 to the band 14.

(2) In a variant of the invention, as illustrated in FIGS. 1-3, the attachment mechanism 50 further includes first 62 and second 66 retaining clips. Each of the clips 62, 66 extends outwardly from the surrounding case 46 along a diameter 70 of the watch module 34 in opposite directions. Each of the clips 62, 66 has a channel 74 through it. The channel 74 has an upper wall 78, a lower wall 82 and is sized and shaped to fit slidably about the band 14. The lower wall 82 includes first 86 and second 90 opposing prongs. The prongs 86, 90 are located at right angles to the diameter 70 and extend inwardly from outer edges 94 of the clips 62, 66 toward each other. The prongs 86, 90 are spaced apart sufficiently to permit an edge 96 of the band 14 to pass between them. When the edge 96 of the band 14 is passed between each of the sets of prongs 86, 90 and turned to lie flat against the lower surface 58 of the surrounding case 46, the band 14 will be removably attached to the watch module 34.

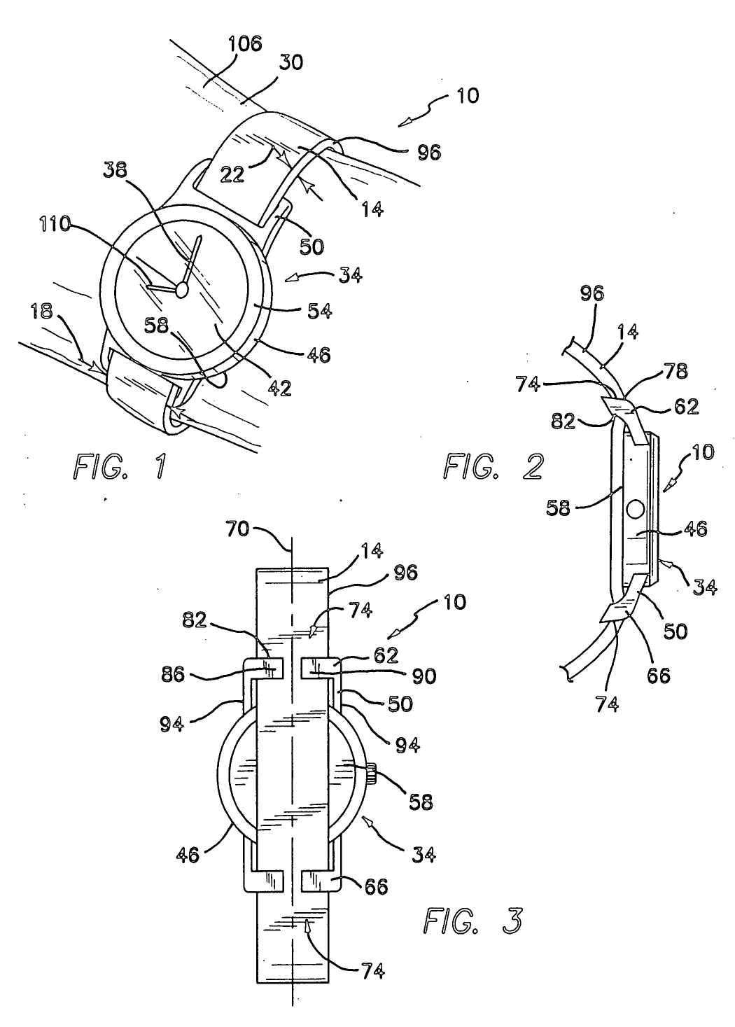

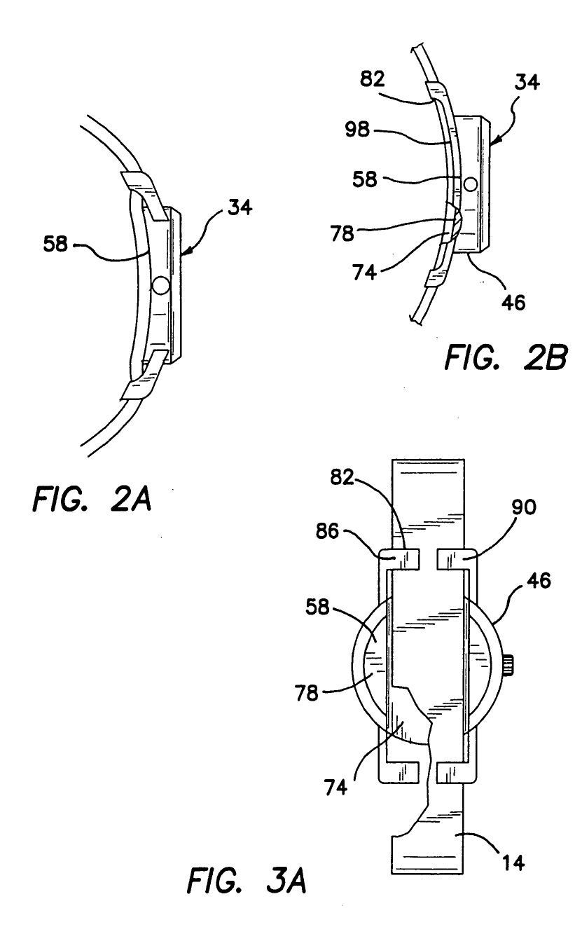

(3) In another variant, as illustrated in FIG. 2B, the watch module 34 further includes a bottom plate 98. The bottom plate 98 is attached to the lower surface 58 of the surrounding case 46 and forms the upper wall 78 of the channel 74. The lower wall 82 includes the first 86 and second 90 opposing prongs descending from side edges 102 of the bottom plate 98.

(4) In still another variant, as illustrated in FIG. 2B, the bottom plate 98 is curved to permit the watch module 34 to fit more closely against the wrist 30 of the wearer 106.

(5) In yet another variant, as illustrated in FIG. 3A, the upper wall 78 of the channel 74 is recessed into the lower surface 58 of the surrounding case 46, thereby permitting the band 14 to fit more closely against the wrist 30 of the wearer 106.

(6) In a further variant, as illustrated in FIG. 1, the watch module 34 includes an analog watch movement 110.

(7) In still a further variant, as illustrated in FIG. 4, the watch module 34 includes a digital watch movement 114.

(8) In yet a further variant, the watch module 34 is waterproof.

(9) In a variant of the invention, as illustrated in FIGS. 11-17, the attachment mechanism 50 further includes at least one first side wall 118. The first side wall 118 is attached at a right angle to the lower surface 58 of the surrounding case 46 and descends from it for a first predetermined distance 122. At least one underband plate. 126 is provided. The plate 126 is attached at a right angle at a proximate edge 130 to a lower edge 134 of the first side wall 118. The plate 126 has a width 138 at least equal to the first predetermined width 18 and is spaced from the lower surface 58 by at least the first predetermined thickness 22. At least one second side wall 142 is provided. The second side wall 142 is attached at a right angle at a distal edge 146 of the underband plate 126 and ascends toward the lower surface 58 for at least the first predetermined distance 122. At least one retaining tab 150 is provided. The retaining tab 150 is attached at a right angle at an upper edge 154 of the second side wall 142 and extends inwardly over the underband plate 126 for a second predetermined distance 158. When the band 14 is inserted between the lower surface 58 of the surrounding case 46 and the underband plate 126 it will be located against the first side wall 118 and when the band 14 is then pushed under the retaining tab 150 it will be located between the first side wall 118 and the second side wall 142, thereby removably attaching the watch module 34 to the band 14.

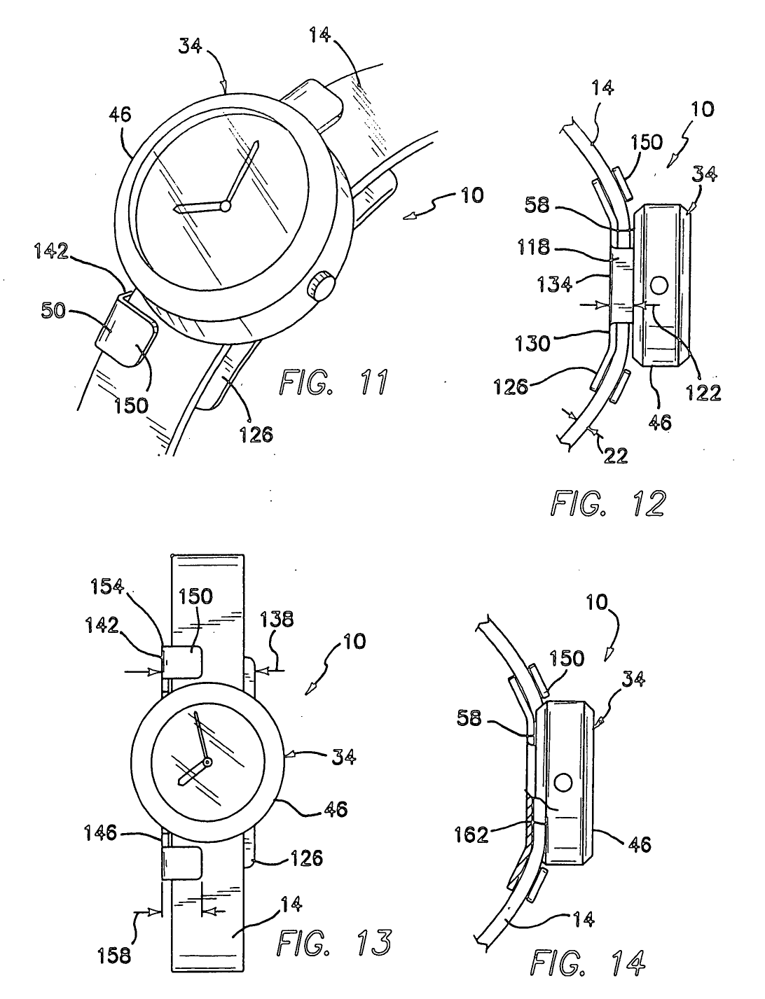

(10) In another variant, as illustrated in FIGS. 12, 14 and 17, the underband plate 126 is curved to permit the watch module 34 to fit more closely against the wrist 30 of the wearer 106.

(11) In still another variant, as illustrated in FIG. 14, the lower surface 58 of the surrounding case 46 is recessed, thereby providing a space 162 for the band 14 and permitting the watch module 34 to fit more closely against the wrist 30 of the wearer 106.

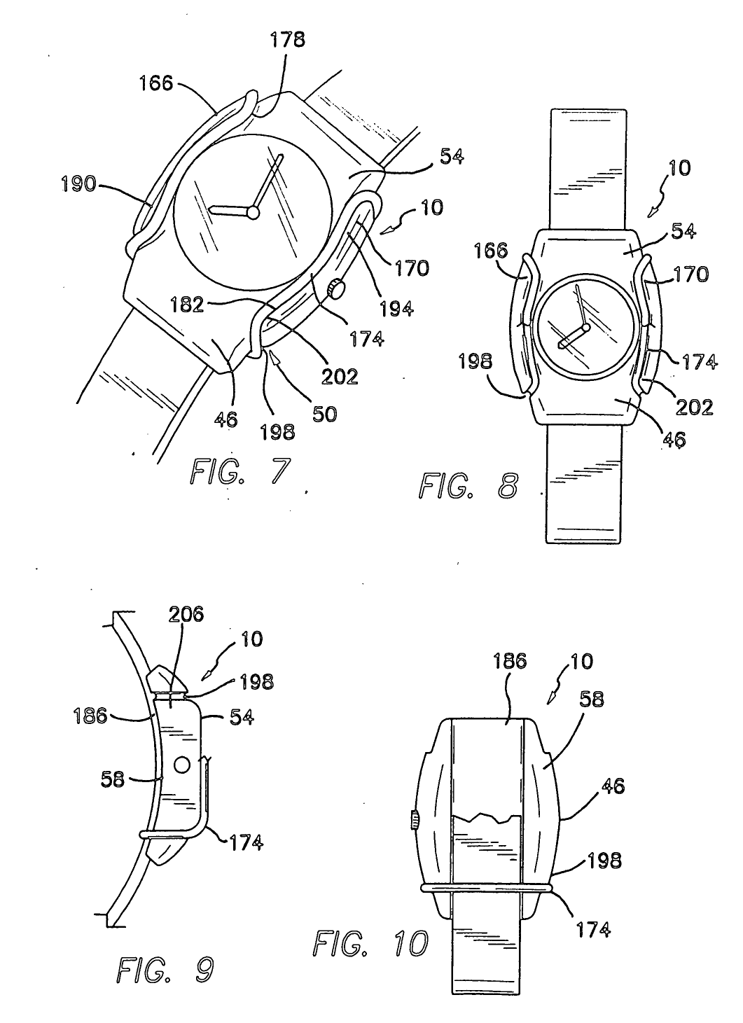

(12) In yet another variant, as illustrated in FIGS. 7-10, the attachment mechanism 50 further includes first 166 and second 170 retaining means. The retaining means 166, 170 extend upwardly from the upper surface 54 of the surrounding case 46. A continuous loop 174 is provided. The loop 174 is formed of resilient material and is sized and shaped to extend from an inner edge 178 of the first retaining means 166, beneath the lower surface 58 of the watch module 34 and the continuous band 14, and over an inner edge 182 of the second retaining means 170, thereby removably attaching the watch module 34 to the band 14.

(13) In a further variant, as illustrated in FIGS. 9 and 10, the attachment mechanism 50 further includes a recess 186. The recess 186 is located in the lower surface 58 of the surrounding case 46, is sized and shaped to fit frictionally about the band 14 and permits the watch module 34 to fit more closely against the wrist 30 of the wearer 106.

(14) In still a further variant, as illustrated in FIG. 9, the lower surface 58 of the surrounding case 46 and the recess 186 are curved, thereby permitting the watch 10 to fit more closely against the wrist 30 of the wearer 106.

(15) In yet a further variant, as illustrated in FIG. 7, the retaining means 166, 170 further includes first 190 and second 194 ridges. The ridges 190, 194 are sized and shaped to retain the continuous loop 174.

(16) In another variant of the invention, as illustrated in FIGS. 7-10, the attachment mechanism 50 further includes at least one side notch 198. The side notch 198 extends downwardly from ends 202 of the first 190 and second 194 ridges along side edges 206 of the surrounding case 46. The notches 198 make attachment of the continuous loop 174 more compact.

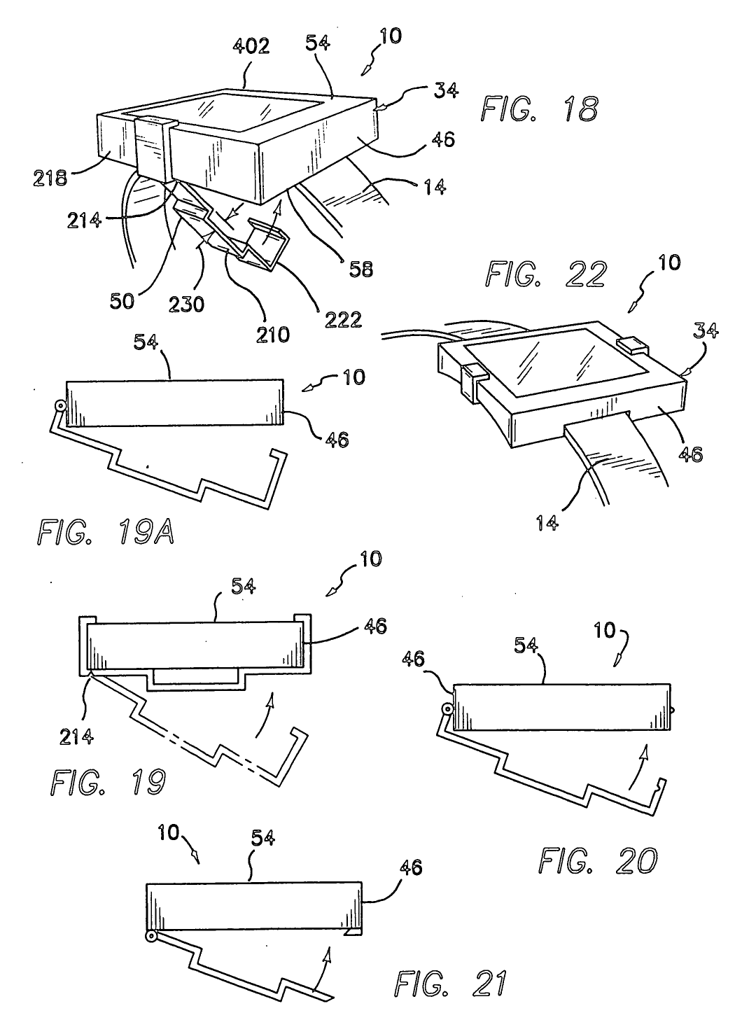

(17) In still another variant, as illustrated in FIGS. 18-22, the attachment mechanism 50 further includes an attachment bracket 210. As illustrated in FIG. 21, the bracket 210 is formed of resilient material, hingedly attached at a first end 214 adjacent a first side.218 of the lower surface 58 of the surrounding case 46 and removably attached at a second end 222 adjacent an opposite second side 226 of the lower surface 58. The bracket 210 is spaced downwardly from the lower surface 58 by a distance 230 slightly less than the first predetermined thickness 22. The bracket 210 bears frictionally against the band 14 when the second end 222 is attached adjacent the opposite second side 226 of the lower surface 58. When the second end 222 of the bracket 210 is detached from adjacent the opposite second side 226, the watch module 34 may be removed from the band 14.

(18) In yet another variant, as illustrated in FIG. 20, the first end 214 of the bracket 210 is hingedly attached at a first point 234 on a first side edge 238 of the surrounding case 46. The bracket 210 descends from the first point 234 below the lower surface 58 of the case 46, extends across the lower surface 58 and ascends to a second point 242 on an opposite second side edge 246 of the case 46. The second end 222 of the bracket 210 is removably attached to the second side edge 246 adjacent the second point 242.

(19) In a further variant, as illustrated in FIG. 22, the attachment mechanism 50 further includes a recess 250. The recess 250 is located in the lower surface 58 of the surrounding case 46, is sized and shaped to fit frictionally about the band 14 and permits the watch module 34 to fit more closely against the wrist 30 of the wearer 106

(20) In still a further variant, as illustrated in FIG. 22, the lower surface 58 of the surrounding case 46 and the recess 250 are curved, thereby permitting the watch 10 to fit more closely against the wrist 30 of the wearer 106.

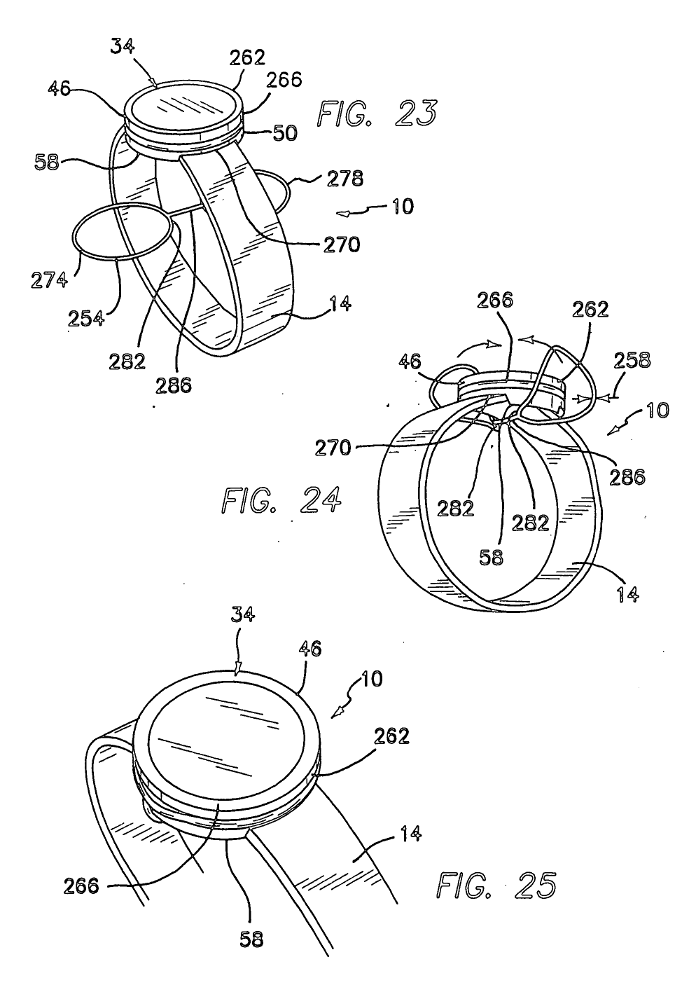

(21) In yet a further variant, as illustrated in FIGS. 23-25, the attachment mechanism 50 further includes an elastic member 254. The member 254 has a first predetermined cross section 258, is sized and shaped to fit elastically about a peripheral edge 262 of the surrounding case 46, under the lower surface 58 of the case 46, across the band 14 and back over the peripheral edge 262. A circumferential groove 266 is provided. The groove 266 is located about the peripheral edge 262 of the surrounding case 46 and is sized and shaped to retain at least one cross section 258 of the elastic member 254. When the elastic member 254 is looped about the circumferential groove 266 and passed under the lower surface 58 of the surrounding case 46, under the band 14 and back up and over the case 46 and stretched over the groove 266, the watch module 34 will be removably attached to the band 14.

(22) In another variant of the invention, as illustrated in FIG. 24, the attachment mechanism 50 further includes a recess 270. The recess 270 is located in the lower surface 58 of the surrounding case 46, is sized and shaped to fit frictionally about the band 14 and permits the watch module 34 to fit more closely against the wrist 30 of the wearer 106.

(23) In still another variant, as illustrated in FIG. 24, the lower surface 58 of the surrounding case 46 and the recess 270 are curved, thereby permitting the watch 10 to fit more closely against the wrist 30 of the wearer 106.

(24) In yet another variant, as illustrated in FIGS. 23-25, the elastic member 254 includes two circular portions 274, 278. The circular portions 274 are sized and shaped to fit elastically about the circumferential groove 266. The circular portions 274 are joined at their peripheral edges 282 by at least one straight member 286. The straight member 286 is sized to extend elastically from the first circular portion 274, under the lower surface 58 of the surrounding case 46, under the band 14 and back to the peripheral edge 282 of the second circular portion 278.

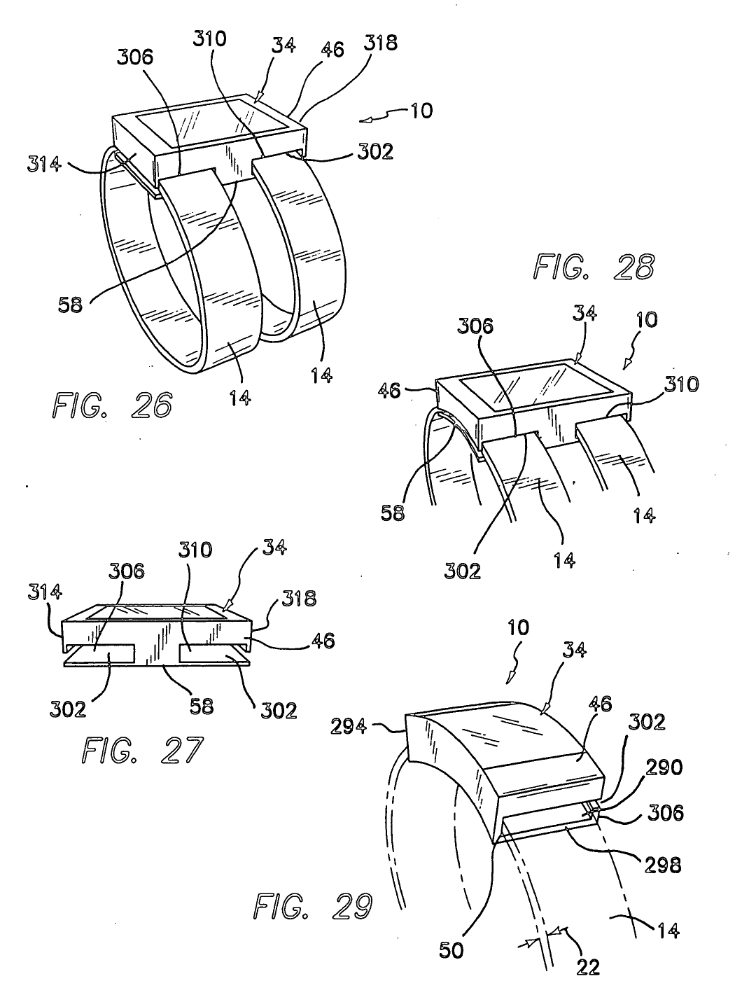

(25) In a further variant, as illustrated in FIGS. 26-29, the attachment mechanism 50 further includes at least one slot 290. The slot 290 extends from a front edge 294 of the surrounding case 46 to a rear edge 298 of the case 46, has an opening 302 at a side edge 306 of the case 46 and is sized and shaped to fit frictionally about the band 14. When the band 14 is inserted into the slot 290, the watch module 34 will be removably attached to the band 14.

(26) In still a further variant, the opening 302 is slightly smaller than the first predetermined thickness 22. When the band 14 is inserted into the slot 290, slight pressure will be required to force the band 14 past the opening 302 and into the slot 290, thereby securing the watch module 34 to the band 14.

(27) In yet a further variant, as illustrated in FIGS. 26-28, the attachment mechanism 50 further includes first 306 and second 310 parallel slots. The slots 306, 310 are located above the lower surface 58 of the surrounding case 46. Each of the slots 306, 310 has an opening 302 at an adjacent side edge 314, 318 of the case 46. Two bands 14 are provided.

Each of the bands 14 is disposed in one of the first 306 and second 310 slots.

(28) In another variant of the invention, as illustrated in FIGS. 28 and 29, the lower surface 58 of the surrounding case 46 is curved, thereby permitting the watch 10 to fit more closely against the wrist 30 of the wearer 106.

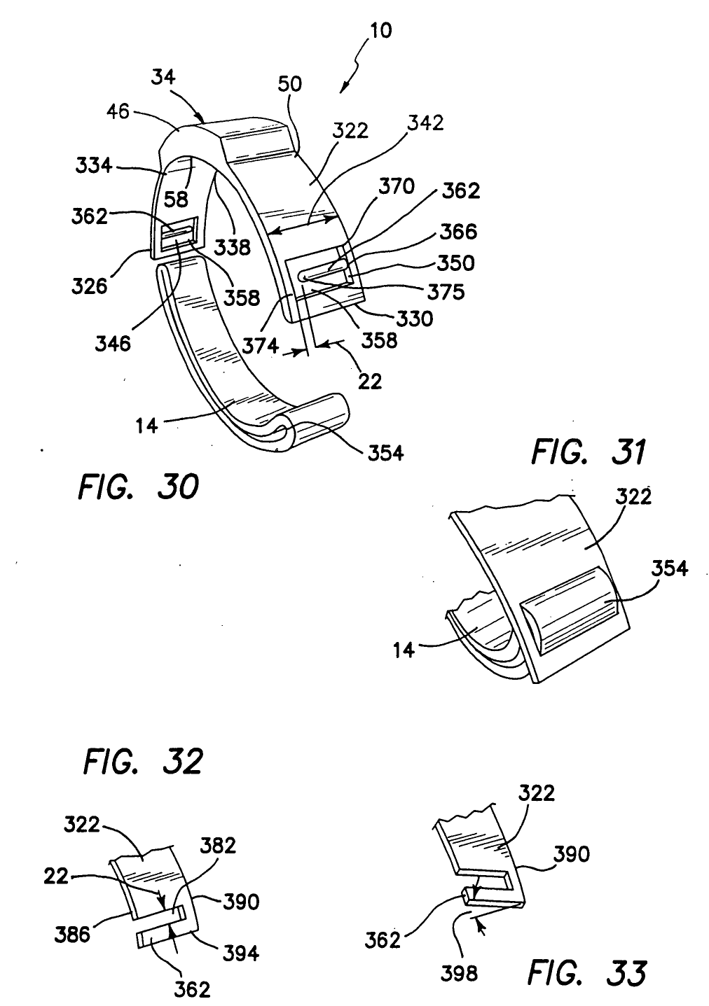

(29) In still another variant, as illustrated in FIGS. 30 and 31, the attachment mechanism 50 further includes a curved support platform 322. The platform 322 has a first end 326 and a second end 330. Each of the ends 326, 330 extends outwardly adjacent first 334 and second 338 side edges of the lower surface 58 of the surrounding case 46, is curved to conform to the wrist 30 of the wearer 106, and has a width 342 at least equal to the first predetermined width 18. First 346 and second 350 attachment notches are provided. Each of the notches 346, 350 is located adjacent one of the first 326 and second 330 ends of the support platform 322 and is sized and shaped to retain a folded loop 354 of the flexible, continuous band 14. When a folded loop 354 of the band 14 is inserted into to each of the first 346 and second 350 attachment notches, the watch module 34 will be removably attached to the folded band 14.

(30) In yet another variant, each of the attachment notches 346, 350 includes an aperture 358 located adjacent each of the first 326 and second 330 ends of the support platform 322. A retaining member 362 is provided. The retaining member 362 extends from a proximal end 366 attached to a lateral inside edge 370 of the aperture 358 toward an opposite lateral inside edge 374. A distal end 378 of the retaining member 362 is spaced from the opposite edge 374 by at least the first predetermined thickness 22. When the folded loop 354 of the flexible, continuous band 14 is inserted into each of the apertures 358 and about the retaining member 362, the watch module 34 will be removably attached to the folded band 14.

(31) In a further variant, as illustrated in FIG. 32, each of the attachment notches 346, 350 includes an opening 382. The opening 382 extends from a first edge 386 of the curved support platform 322 toward a second opposite edge 390 of the platform 322. The opening 382 defines a retaining member 362 disposed at a distal end 394 of the support platform 322, the retaining member 362 is spaced outwardly from the opening 382 by at least the first predetermined thickness 22. When the folded loop 354 of the flexible, continuous band 14 is disposed through the opening 382 and about each of the retaining members 362 the watch module 34 will be removably attached to the folded band 14.

(32) In still a further variant of the invention, as illustrated in FIG. 33, each of the retaining members 362 is attached to the second edge 390 of the support platform 322 at an acute angle 398, thereby more securely attaching the watch module 34 to the folded band 14.

(33) In yet a further variant, as illustrated in FIGS. 18, 19 and 22, the attachment mechanism 50 further includes an attachment bracket 210. The bracket 210 is formed of resilient material, hingedly attached at a first end 214 adjacent a first side 218 of the lower surface 58 of the surrounding case 46 and removably attached at a second end 222 adjacent an opposite second side 402 of the upper surface 54 of the case 46. The bracket 210 is spaced downwardly from the lower surface 58 by a distance 230 slightly less than the first predetermined thickness 22. The bracket 210 bears frictionally against the band 14 when the second end 222 is attached adjacent the opposite second side 402 of the upper surface 54. When the second end 222 of the bracket 210 is detached from adjacent the opposite second side 402, the watch module 30 may be removed from the band 14.

(34) In another variant, as illustrated in FIG. 19A, the first end 214 of the bracket 210 is hingedly attached at a first point 234 on the first side edge 238 of the surrounding case 46. The bracket 210 descends from the first point 234 below the lower surface 58 of the case 46, extends across the lower surface 58 and ascends to a second point 406 on an opposite second side 402 of the upper surface 54 of the case 46. The second end 222 of the bracket 210 is removably attached to the upper surface 54 adjacent the second point 406

(35) In still another variant, as illustrated in FIG. 22, the attachment mechanism 50 further includes a recess 250. The recess 250 is located in the lower surface 58 of the surrounding case 46, is sized and shaped to fit frictionally about the band 14 and permits the watch module 34 to fit more closely against the wrist 30 of the wearer 106

(36) In a further variant, as illustrated in FIG. 22, the lower surface 58 of the surrounding case 46 and the recess 250 are curved, thereby permitting the watch 10 to fit more closely against the wrist 30 of the wearer 106.

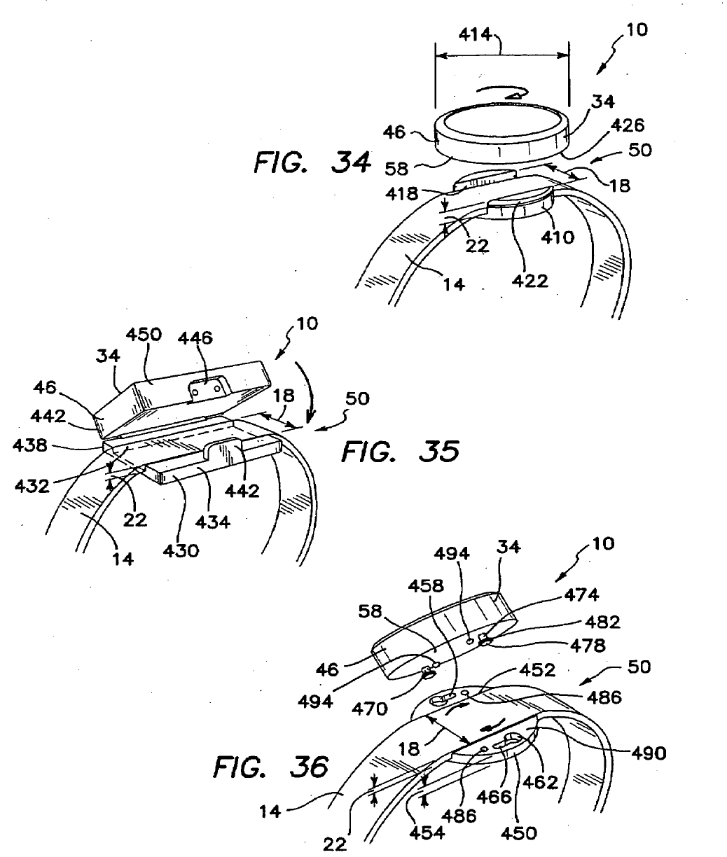

(37) In another variant of the invention, as illustrated in FIG. 34, the attachment mechanism 50 includes an underband fastener 410. The fastener 410 is cylindrical, has a diameter less than an outer horizontal dimension 414 of the watch module 34, a horizontal slot 418 at least as wide as the first predetermined width 18 and approximately as deep as the first predetermined thickness 22 and a surrounding external thread 422. The lower surface 58 of the surrounding case 46 has a recess 426. The recess 426 is sized, shaped and matingly threaded to receive the underband fastener 410. The flexible, continuous band 14 is located within the horizontal slot 418 and the underband fastener 410 is threaded into the recess 426 and the watch module 34 is removably attached to the band 14.

(38) In still another variant, as illustrated in FIG. 35, the attachment mechanism 50 includes a band retaining tray 430. The retaining tray 430 has a horizontal slot 432 at least as wide as the first predetermined width 18 and approximately as deep as the first predetermined thickness 22, first 434 and second 438 side edges adjacent the slot 432 and a locking tab 442 extending upwardly from the first side edge 434. The retaining tray 430 is hingedly attached at the second side edge 438 to the surrounding case 46 at a side edge 442 of the case 46. A mating locking recess 446 is provided. The locking recess 446 is located at an opposite side edge 450 of the surrounding case 46 and is sized and shaped to removably attach the band retaining tray 430 to the surrounding case 46 at the first side edge 434. The flexible, continuous band 14 is located within the horizontal slot 418, the locking tab 442 engages the mating locking recess 446 and the watch module 34 is removably attached to the band 14.

(39) In yet another variant, as illustrated in FIG. 36, the attachment mechanism 50 includes a retaining disk 450. The retaining disk 450 has a second predetermined thickness 454, a horizontal slot 452 at least as wide as the first predetermined width 18 and approximately as deep as the first predetermined thickness 22, at least two curved keyhole-shaped apertures 458 located adjacent the horizontal slot 452. The keyhole-shaped aperture 458 has a wide portion 462 and a narrow portion 466. At least two mating securing protrusions 470 are provided. The protrusions 470 have a shaft portion 474 extending downwardly from the lower surface 58 of the surrounding case 46 and a head portion 478 located at a lower end 482 of the shaft portion 474. The shaft portion 474 is slightly longer than the second predetermined thickness 454, and is sized and shaped to fit slidably within the narrow portion 466 of the keyhole-shaped aperture 458. The head portion 478 is sized and shaped to fit slidably within the wide portion 462 of the keyhole-shaped aperture 458. The flexible, continuous band 14 is located within the horizontal slot 452, the head portion 478 of the mating securing protrusion 470 passes through the wide portion 462 of the keyhole-shaped aperture 458, the watch module 34 is twisted with respect to the retaining disk 450 and the shaft portion 474 enters the narrow portion 466 of the keyhole-shaped aperture 458, thereby removably securing the flexible band 14 between the retaining disk 450 and the lower surface 58 of the surrounding case 46.

(40) In still another variant, the attachment mechanism 50 includes at least one detent 486. The detent 486 is located on either of the lower surface 58 of the surrounding case 46 and an upper surface 490 of the retaining disk 450. At least one mating detent button 494 is provided. The mating detent button 494 extends from the surrounding case 46 or the upper surface 490 of the retaining disk 450 and removably engages the at least one detent 486 to deter rotation of the retaining disk 450 with respect to the surrounding case 46, thereby more securely attaching the watch module 34 to the flexible band 14.

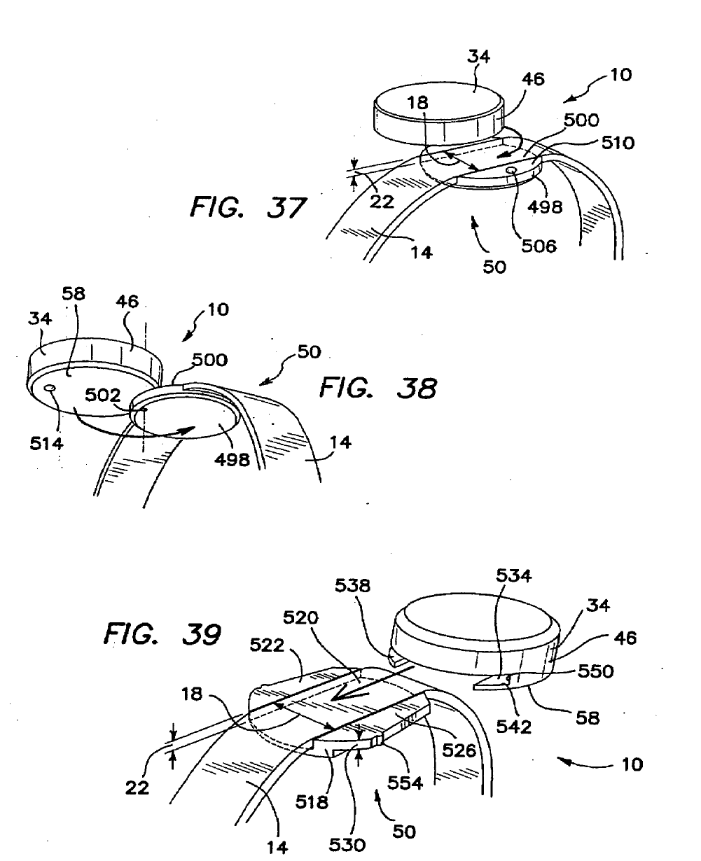

(41) In yet another variant, as illustrated in FIGS. 37 and 38, the attachment mechanism 50 includes a sliding retainer plate 498. The retainer plate 498 has a horizontal slot 500 at least as wide as the first predetermined width 18 and approximately as deep as the first predetermined thickness 22. It is rotatably attached to the lower surface 58 of the surrounding case 46 at a point 502 adjacent the horizontal slot 500. At least one detent 506 is provided. The detent 506 is located on either of the lower surface 58 of the surrounding case 46 and an upper surface 510 of the retainer plate 498. At least one mating detent button 514 is provided. The mating detent button 514 extends from the surrounding case 46 or the upper surface 510 of the retainer plate 498 and removably engages the at least one detent 506 to deter rotation of the retainer plate 498 with respect to the surrounding case 46, thereby removably attaching the watch module 34 to the flexible band 14.

(42) In a further variant, as illustrated in FIG. 39, the attachment mechanism 50 includes a retaining platform 518. The retaining platform 518 has a horizontal slot 520 at least as wide as the first predetermined width 18 and approximately as deep as the first predetermined thickness 22. The platform 518 has first 522 and second 526 side edges. The side edges 522, 526 are parallel to and extend outwardly from the horizontal slot 520, and have a third predetermined thickness 530. A receiving channel 534 is provided. The receiving channel 534 is located in the lower surface 58 of the surrounding case 46, has first 538 and second 542 parallel receiving notches. The notches 538, 542 are sized and shaped to fit slidably over the first 522 and second 526 side edges of the retaining platform 518, thereby removably attaching the watch module 34 to the flexible band 14.

(43) In still a further variant, the attachment mechanism 50 includes at least one detent (not shown). The detent is located on either of the first 522 and second 526 side edges of the retaining platform 518 and inner surfaces 550 of the first 538 and second 542 parallel receiving notches. At least one mating detent button 554 is provided. The mating detent button 554 extends from either of first 522 and second 526 side edges of the retaining platform 518 and inner surfaces 550 of the first 538 and second 542 parallel receiving notches.

The mating detent button 554 removably engages the at least one detent to deter sliding of the retaining platform 518 with respect to the surrounding case 46, thereby more securely attaching the watch module 34 to the flexible band 14.

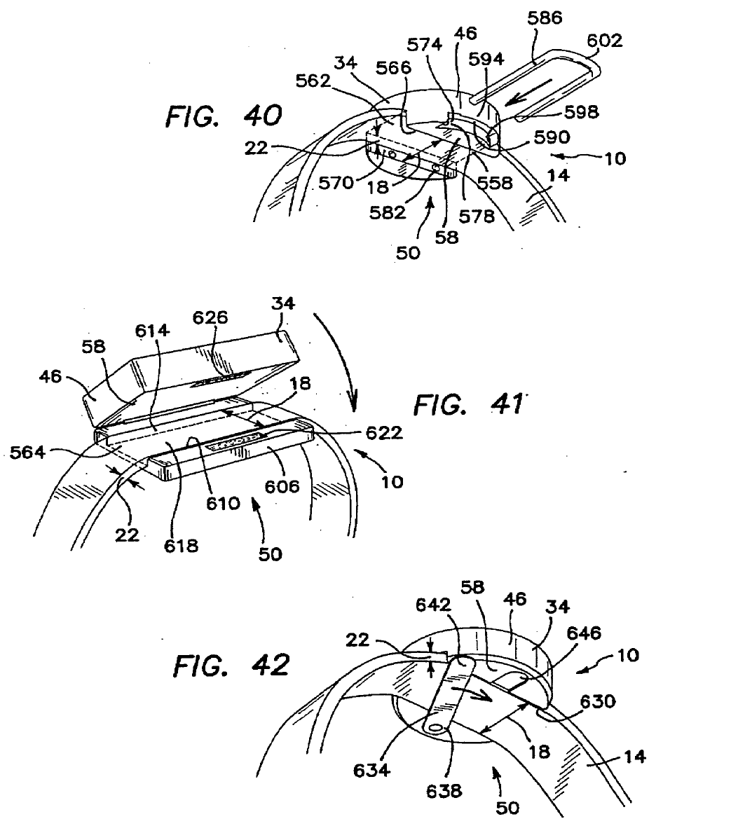

(44) In yet a further variant, as illustrated in FIG. 40, the attachment mechanism 50 includes a horizontal slot 558 at least as wide as the first predetermined width 18 and deeper than the first predetermined thickness 22. The slot 558 has an upper surface 562 and substantially vertical first 566 and second 570 side walls. The horizontal slot 558 is located in the lower surface 58 of the surrounding case 46. At least one securing aperture 574 is provided. The securing aperture 574 penetrates the surrounding case 46 and the first vertical side wall 566 at a point 578 spaced from the upper surface 562 by approximately the first predetermined thickness 22. At least one mating receiving recess 582 is provided. The receiving recess 582 is located in the opposite second vertical side wall 570 in alignment with the securing aperture 574. At least one retaining rod 586 is provided. The retaining rod 586 is sized and shaped to fit frictionally through the securing aperture 574 and into the receiving recess 582. The flexible band 14 is located in the horizontal slot 558, the retaining rod 586 is inserted into the securing aperture 574, under the flexible band 14 and into the mating receiving recess 582, thereby removably attaching the watch module 34 to the flexible band 14.

(45) In another variant of the invention, the attachment mechanism 50 includes a locking lip 590. The locking lip 590 is located in a side edge 594 of the surrounding case 46 slightly below an upper edge 598 of the securing aperture 574. The locking lip 590 bears against the retaining rod 586 as the rod 586 is inserted into the securing aperture 574 and thereby securing an end 602 of the retaining rod 586 and preventing the rod 586 from moving backward out of the aperture 574 and thus removably attaching the watch module 34 to the flexible band 14.

(46) In still another variant, as illustrated in FIG. 41, the attachment mechanism 50 includes an underband tray 606. The tray 606 has first 610 and second 614 side edges, a horizontal slot 618 at least as wide as the first predetermined width 18 and at least as deep as the first predetermined thickness 22 located between the side edges 610, 614. The tray 606 has either of a magnet 622 and ferromagnetic material 626 located between the first side edge 610 and the slot 618. The tray 606 is hingedly attached adjacent the second side edge 614 to the surrounding case 46. The surrounding case 46 has either of a magnet 622 and ferromagnetic material 626 located in the lower surface 58 to removably engage either of the magnet 622 and the ferromagnetic material 626 located in the tray 606, thereby removably attaching the watch module 34 to the flexible band 14.

(47) In yet another variant, as illustrated in FIG. 42, the attachment mechanism 50 includes a horizontal slot 630 at least as wide as the first predetermined width 18 and substantially as deep as the first predetermined thickness 22, the horizontal slot 630 is located in the lower surface 58 of the surrounding case 46. A spring clip 634 is provided. The spring clip 634 has a first end 638 and a second end 642 and is pivotally mounted at the first end 638 to the lower surface 58 of the surrounding case 46. The surrounding case 46 has a retaining recess 646. The recess 646 is located in the lower surface 58 adjacent to the horizontal slot 630 and sized and shaped to removably receive the second end 642 of the spring clip 634. The horizontal slot 630 receives the flexible band 14, the spring clip 634 slides pivotally over the band 14 and removably engages the retaining recess 646, thererby removably attaching the watch module 34 to the flexible band 14.

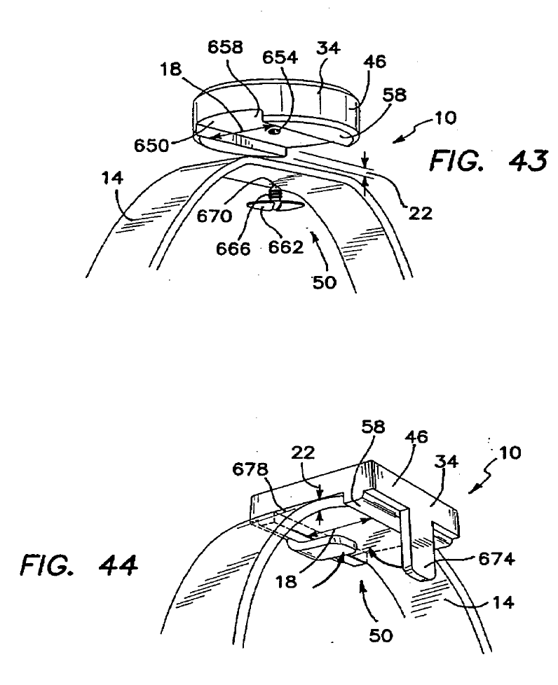

(48) In a further variant, as illustrated in FIG. 43, the attachment mechanism 50 includes a horizontal slot 650 at least as wide as the first predetermined width 18 and substantially as deep as the first predetermined thickness 22, the horizontal slot 650 is located in the lower surface 58 of the surrounding case 46. At least one threaded hole 654 is provided. The threaded hole 654 is located in an upper surface 658 of the horizontal slot 650. A screw 662 is provided. The screw 662 has a mating thread 666 for removably attaching to the threaded hole 654 and a point 670 for piercing the flexible band 14. The screw 662 penetrates the flexible band 14 and removably engages the threaded hole 654, thereby removably attaching the watch module 34 to the flexible band 14.

(49) In still a further variant, as illustrated in FIG. 44, the attachment mechanism 50 includes at least one retaining arm 674. The retaining arm 674 is formed of malleable material and descends from the surrounding case 46 for a distance equal to at least a portion of the first predetermined width 18. The retaining arm 674 is bendable over the flexible band 14 and removably attaches the watch module 34 to the flexible band 14.

(50) In yet a further variant, the attachment mechanism 50 includes a horizontal slot 678 at least as wide as the first predetermined width 18 and substantially as deep as the first predetermined thickness 22. The horizontal slot 678 is located in the lower surface 58 of the surrounding case 46.

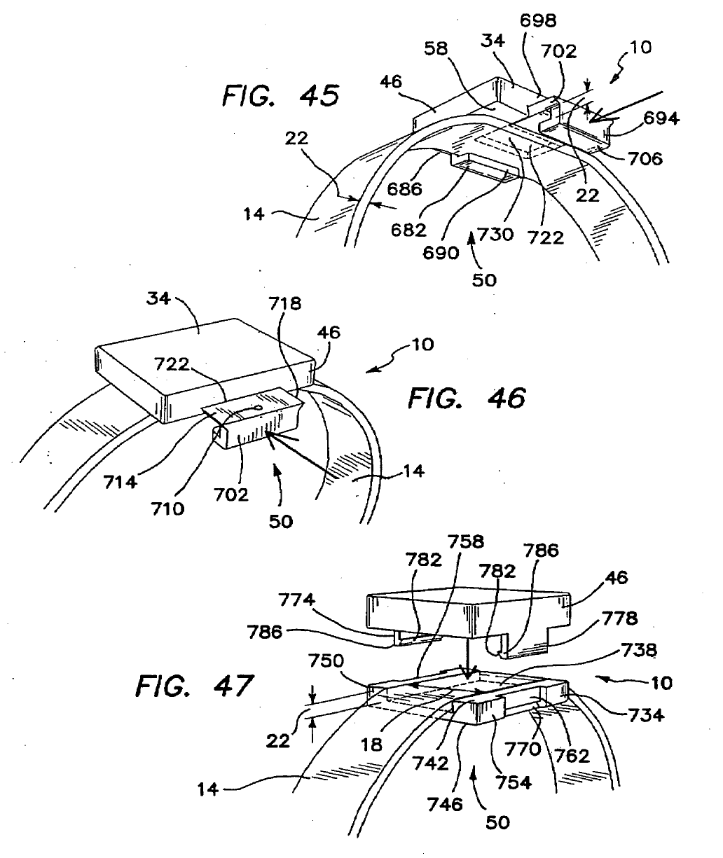

(51) In another variant of the invention, as illustrated in FIGS. 45 and 46, the attachment mechanism 50 includes a fixed retaining arm 682. The fixed arm 682 descends from a side edge 686 of the surrounding case 46 and has a first inturned lip 690. The first lip 690 is spaced from the lower surface 58 of surrounding case 46 by the first predetermined thickness 22. A sliding retaining arm 694 is provided. The sliding arm 694 descends from an opposite side edge 698 of the surrounding case 46, has an upper slide member 702, and a second inturned lip 706. The second lip 706 is spaced from the lower surface 58 of surrounding case 46 by the first predetermined thickness 22. The upper slide member 702 has a protrusion 710 on either of an upper surface 714 and a lower surface 718 of the member 702 and fits slidably within a slot 722 in the surrounding case 46 adjacent the lower surface 58. The slot 722 has a detent (not shown) on an interior wall 730 of the slot 722. The detent removably receives the protrusion 710. The first 690 and second 706 inturned lips removably engage the flexible band 14, the protrusion 710 on the slide member 702 removably engages the detent and thus removably attaches the watch module 34 to the flexible band 14.

(52) In still another variant, as illustrated in FIG. 47, the attachment mechanism 50 includes a receiving tray 734. The receiving tray 734 has a horizontal slot 738 at least as wide as the first predetermined width 18 and approximately as deep as the first predetermined thickness 22, an upper surface 742, a lower surface 746 and first 750 and second 754 side edges, the side edges 750, 754 are parallel to and extend outwardly from the horizontal slot 738. First 758 and second 762 attachment notches are provided. The notches 758, 762 are located at the first 750 and second 754 side edges, respectively, and extend from the upper surface 742 to the lower surface 746 of the tray 734 and inwardly from the side edges 750, 754. First (not shown) and second 770 relief cuts are provided. The relief cuts 770 are located at the lower surface 746 of the tray 734 and extend inwardly from the first 758 and second 762 attachment notches. First 774 and second 778 snap fingers are provided. The snap fingers 774, 778 extend downwardly from the surrounding case 46 and have a securing ledge 782 extending inwardly from lower ends 786 of the fingers 774, 778. The first 774 and second 778 snap fingers are sized and shaped to fit slidably within the attachment notches 758, 762 and the securing ledges 782 are sized and shaped to fit removably into the first and second 770 relief cuts. The flexible band 14 is located in the horizontal slot 738 in the receiving tray 734. The tray 734 is removably attached to the snap fingers 774, 778 and removably attaches the watch module 34 to the flexible band 14.

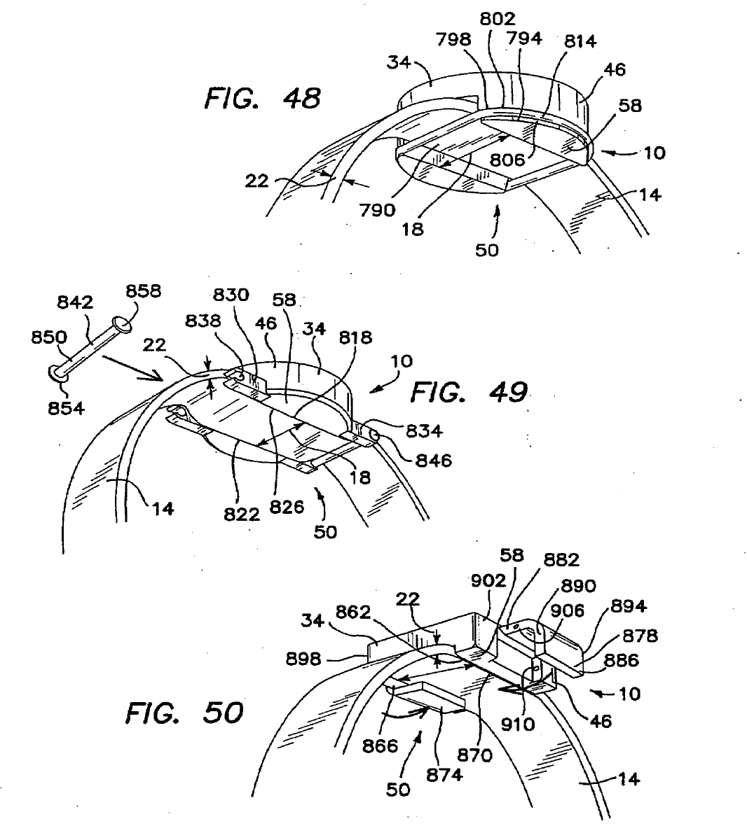

(53) In yet another variant, as illustrated in FIG. 48, the attachment mechanism 50 includes a horizontal slot 790 at least as wide as the first predetermined width 18 and deeper than the first predetermined thickness 22. The horizontal slot 790 is located in the lower surface 58 of the surrounding case 46. A retaining slot 794 is provided. The retaining slot 794 is located about a perimeter 798 of the surrounding case 46. The slot 794 has an upper edge 802 and a lower edge 806 and is spaced upwardly from the lower surface 58 of the surrounding case 46. The upper edge 802 is spaced downwardly from an upper surface 810 of the horizontal slot 790 by approximately the first predetermined thickness 22. An elastic member 814 is provided. The elastic member 814 is sized and shaped to fit closely between the upper edge 802 and the lower edge 806 of the retaining slot 794. The flexible band 14 is located within the horizontal slot 790. The elastic member 814 is located within the retaining slot 794 and removably attaches the watch module 34 to the flexible band 14.

(54) In still another variant, as illustrated in FIG. 49, the attachment mechanism 50 includes a horizontal slot 818 at least as wide as the first predetermined width 18 and substantially as deep as the first predetermined thickness 22. The horizontal slot 818 is located in the lower surface 58 of the surrounding case 46. The slot 818 has first 822 and second 826 parallel side edges. First 830 and second 834 retaining brackets are provided. The brackets 830, 834 extend outwardly from the first 818 and second 822 parallel side edges in opposite directions. Each of the retaining brackets 830, 834 terminates in a pair of pin fastening notches 838. The notches 838 are located on either side of the horizontal slot 818. First 842 and second 846 securing pins are provided. Each of the pins 842, 846 has a shaft 850 sized and shaped to fit frictionally within the pin fastening notches 838 and first 854 and second 858 end caps. The ends caps 854, 858 are larger than the notches 838. The flexible band 14 is located within the horizontal slot 818, the securing pins 842, 846 are located within the pin fastening notches 838 and removably attach the watch module 34 to the flexible band 14.

(55) In a further variant, as illustrated in FIG. 50, the attachment mechanism 50 includes a horizontal slot 862 at least as wide as the first predetermined width 18 and substantially as deep as the first predetermined thickness 22. The horizontal slot 862 is located in the lower surface 58 of the surrounding case 46. The slot 862 has first 866 and second 870 parallel side edges. First 874 and second 878 L-shaped clips are provided. Each of the L-shaped clips 874, 878 has a first end 882, a second end 886, first 890 and second 894 side edges and is hingedly attached to opposite side edges 898, 902 of the surrounding case 46. The clips 874, 878 are sized and shaped to constrain the flexible band 14 in the horizontal slot 862 when folded below the case 46. Each of the clips 874, 878 has a raised retaining button 906. Each of the side edges 898, 902 of the surrounding case 46 has a receiving detent 910. Each of the detents 910 is sized and shaped to removably retain one of the retaining buttons 906. The flexible band 14 is located within the horizontal slot 862, the L-shaped clips 874, 878 are pivoted downwardly to constrain the band 14 within the slot 862 and the retaining buttons 906 engage the receiving detents 910 to removably attach the watch module 34 to the band 14.

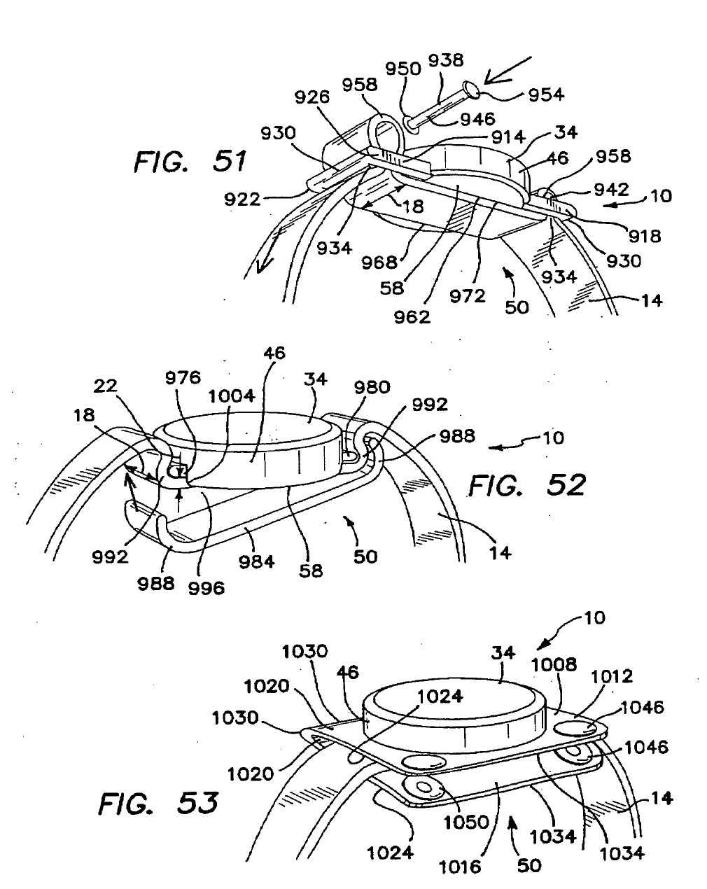

(56) In still a further variant, as illustrated in FIG. 51, the attachment mechanism 50 includes first 914 and second 918 retaining brackets. Each of the retaining brackets 914, 918 extends outwardly from the surrounding case 46 in opposite directions parallel to the flexible band 14. Each of the retaining brackets 914, 918 has first 922 and second 926 parallel side plates, the side plates 922, 926 are spaced apart by at least the first predetermined width 18 and terminate in an end bar 930 connecting the side plates 922, 926. The surrounding case 46, each pair of side plates 922, 926 and each end bar 930 define an aperture 934 at least twice as long as the first predetermined thickness 22. First 938 and second 942 securing pins are provided. Each of the pins 938, 942 has a shaft 946 at least as long as the first predetermined width 18 and first 950 and second 954 end caps. The ends caps 950, 954 are larger than the shaft 946. The flexible band 14 is located beneath the surrounding case 46 and has loops 958 extending upwardly through the apertures 934. The securing pins 938, 942 are located within the loops 958 and the end caps 950, 954 secure the pins 938, 942 to the band 14, removably attaching the watch module 34 to the band 14.

(57) In another variant of the invention, the surrounding case 46 includes a horizontal slot 962. The slot 962 is at least as wide as the first predetermined width 18 and substantially as deep as the first predetermined thickness 22. The horizontal slot 962 is located in the lower surface 58 of the surrounding case 46, the slot 962 has first 968 and second 972 parallel side edges.

(58) In still another variant, as illustrated in FIG. 52, the attachment mechanism 50 includes first 976 and second 980 retaining ledges. Each of the retaining ledges 976, 980 extends outwardly from the surrounding case 46 in opposite directions parallel to the flexible band 14. A retaining clip 984 is provided. The clip 984 is formed of resilient material, is sized and shaped to fit beneath the surrounding case 46 and flexible band 14 and has curved ends 988. The ends 988 urge loops 992 of the flexible band 14 over the retaining ledges 976, 980 and inwardly toward the surrounding case 46. The curved ends 988 extend upwardly past the ledges 976, 980. The retaining clip 984 removably attaches the watch module 34 to the flexible band 14.

(59) In yet another variant, the surrounding case 46 includes a horizontal slot 996. The slot 996 is at least as wide as the first predetermined width 18 and substantially as deep as the first predetermined thickness 22. The horizontal slot 996 is located in the lower surface 58 of the surrounding case 46. The slot 996 has first (not shown) and second 1004 parallel side edges.

(60) In a further variant, as illustrated in FIG. 53, the attachment mechanism 50 includes an attachment sleeve 1008. The sleeve 1008 has a planar upper portion 1012 and a planar lower portion 1016. Each of the portions 1012, 1016 has an upper surface 1020, a lower surface 1024, first 1030 and second 1034 side edges. The upper portion 1012 is attached to the lower surface 58 of the surrounding case 46 and hingedly attached at the first side edge 1030 to the first side edge 1030 of the lower portion 1016. At least one attachment means 1046 is provided. The attachment 1046 means removably secures the upper portion. 1012 to the lower portion 1016 at the second side edges 1034. The flexible band 14 is removably secured between the upper portion 1012 and the lower portion 1016, thereby removably attaching the watch module 34 to the flexible band 14.

(61) In still a further variant, the attachment means 1046 is selected from the group consisting of snap 1050, button (not shown), hook and loop fastener (not shown) and slot and turn button fastener (not shown).

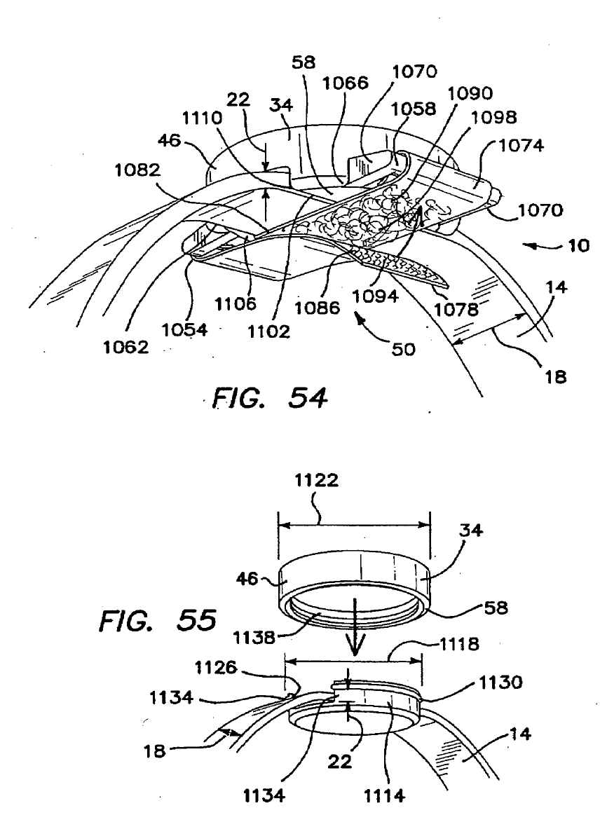

(62) In yet a further variant, as illustrated in FIG. 54, the attachment mechanism 50 includes first 1054 and second 1058 receiving bars. Each of the bars 1054, 1058 is attached to opposite lower edges 1062, 1066 of the surrounding case 46 and spaced outwardly from the case 46 by a pair of support brackets 1070. A securing strap 1074 is provided. The strap 1074 is formed of flexible material, has a first end 1078, a second end 1082, an upper surface 1086 and a lower surface 1090. The upper surface 1086 has a hooking attachment means 1094 adjacent the first end 1078. The lower surface 1090 has a loop attachment means 1098 adjacent the second end 1082. The flexible band 14 is located beneath the lower surface 58 of the surrounding case 46. The securing strap 1074 is looped over the receiving bars 1054, 1058 and under the flexible band 14. The second end 1082 is folded over the first end 1078, the hooking attachment means 1094 removably engages the loop attachment means 1098 and removably secures the watch module 34 to the flexible band 14.

(63) In still a further variant of the invention, the surrounding case 46 includes a horizontal slot 1102. The slot 1102 is at least as wide as the first predetermined width 18 and substantially as deep as the first predetermined thickness 22. The horizontal slot 1102 is located in the lower surface 58 of the surrounding case 46. The slot 1102 has first 1106 and second 1110 parallel side edges.

(64) In a final variant, as illustrated in FIG. 55, a subband fastener 1114 is provided. The fastener 1114 is formed of resilient material, cylindrical, has a diameter 1118 less than an outer horizontal dimension 1122 of the watch module 34. The fastener 1114 has a horizontal slot 1126 at least as wide as the first predetermined width 18, approximately as deep as the first predetermined thickness 22 and a peripheral lip 1130. The lip 1130 extends on either side 1134 of the slot 1126. The lower surface 58 of the surrounding case 46 has a recess 1138. The recess 1138 is sized, and shaped to receive the peripheral lip 1130 of the subband fastener 1114.

The flexible, continuous band 14 is located within the horizontal slot 1126 and the subband fastener 1114 is fitted frictionally into the recess 1138. The watch module34 will be removably attached to the band 14.

The flexible band with clip-on watch 10 has been described with reference to particular embodiments. Other modifications and enhancements can be made without departing from the spirit and scope of the claims that follow.

1. A flexible band with clip-on watch comprising:
at least one flexible, continuous band, said band having a first predetermined width and a first predetermined thickness, being formed of resilient material and being sized and shaped to fit over a wearer's hand and loosely about said wearer's wrist;
a watch module, said watch module comprising a time-keeping movement, a display, a surrounding case, and an attachment mechanism, said case having an upper surface and a lower surface; and
said attachment mechanism removably joining said watch module to said at least one band.

2. The flexible band with clip-on watch, as described in claim 1, wherein said attachment mechanism further comprises:
an underband fastener, said fastener being cylindrical, having a diameter less than an outer horizontal dimension of said watch module, a horizontal slot at least as wide as said first predetermined width and approximately as deep as said first predetermined thickness and a surrounding external thread;
said lower surface of said surrounding case having a recess, said recess being sized, shaped and matingly threaded to receive said underband fastener; and
said flexible, continuous band being disposed within said horizontal slot and said underband fastener being threaded into said recess, said watch module will be removably attached to said band.

3. The flexible band with clip-on watch, as described in claim 1, wherein said attachment mechanism further comprises:
a band retaining tray, said retaining tray having a horizontal slot at least as wide as said first predetermined width and approximately as deep as said first predetermined thickness, first and second side edges adjacent said slot and a locking tab extending upwardly from said first side edge;
said retaining tray being hingedly attached at said second side edge to said surrounding case at a side edge thereof;
a mating locking recess, said locking recess disposed at an opposite side edge of said surrounding case and being sized and shaped to removably attach said band retaining tray to said surrounding case at said first side edge; and
said flexible, continuous band being disposed within said horizontal slot and said locking tab engaging said mating locking recess, said watch module will be removably attached to said band.

4. The flexible band with clip-on watch, as described in claim 1, wherein said attachment mechanism further comprises:
a retaining disk, said retaining disk having a second predetermined thickness, a horizontal slot at least as wide as said first predetermined width and approximately as deep as said first predetermined thickness, at least two curved keyhole-shaped apertures disposed adjacent said horizontal slot, said keyhole-shaped aperture having a wide portion and a narrow portion;
at least two mating securing protrusions, said protrusions having a shaft portion extending downwardly from said lower surface of said surrounding case and a head portion disposed at a lower end of said shaft portion;
said shaft portion being slightly longer than said second predetermined thickness, and being sized and shaped to fit slidably within said narrow portion of said keyhole-shaped aperture;
said head portion being sized and shaped to fit slidably within said wide portion of said keyhole-shaped aperture; and
said flexible, continuous band being disposed within said horizontal slot, said head portion of said mating securing protrusion passing through said wide portion of said keyhole-shaped aperture, said watch module being twisted with respect to said retaining disk and said shaft portion entering said narrow portion of said keyhole-shaped aperture, thereby removably securing said flexible band between said retaining disk and said lower surface of said surrounding case.

5. The flexible band with clip-on watch, as described in claim 39, wherein said attachment mechanism further comprises:
at least one detent, said detent being disposed on either of said lower surface of said surrounding case and an upper surface of said retaining disk; and
at least one mating detent button, said mating detent button extending from either of said surrounding case and said upper surface of said retaining disk and removably engaging said at least one detent to deter rotation of said retaining disk with respect to said surrounding case, thereby more securely attaching said watch module to said flexible band.

6. The flexible band with clip-on watch, as described in claim 1, wherein said attachment mechanism further comprises:
a sliding retainer plate, said retainer plate having a horizontal slot at least as wide as said first predetermined width and approximately as deep as said first predetermined thickness, and being rotatably attached to said lower surface of said surrounding case at a point adjacent said horizontal slot;
at least one detent, said detent being disposed on either of said lower surface of said surrounding case and an upper surface of said retainer plate; and
at least one mating detent button, said mating detent button extending from either of said surrounding case and said upper surface of said retainer plate and removably engaging said at least one detent to deter rotation of said retainer plate with respect to said surrounding case, thereby removably attaching said watch module to said flexible band.

7. The flexible band with clip-on watch, as described in claim 1, wherein said attachment mechanism further comprises:
a retaining platform, said retaining platform having a horizontal slot at least as wide as said first predetermined width and approximately as deep as said first predetermined thickness, first and second side edges, said side edges being parallel to and extending outwardly from said horizontal slot, and having a third predetermined thickness;
a receiving channel, said receiving channel being disposed in said lower surface of said surrounding case, having first and second parallel receiving notches, said notches being sized and shaped to fit slidably over said first and second side edges of said retaining platform, thereby removably attaching said watch module to said flexible band.

8. The flexible band with clip-on watch, as described in claim 7, wherein said attachment mechanism further comprises:
at least one detent, said detent being disposed on either of said first and second side edges of said retaining platform and inner surfaces of said first and second parallel receiving notches; and
at least one mating detent button, said mating detent button extending from either of first and second side edges of said retaining platform and inner surfaces of said first and second parallel receiving notches and removably engaging said at least one detent to deter sliding of said retaining platform with respect to said surrounding case, thereby more securely attaching said watch module to said flexible band.

9. The flexible band with clip-on watch, as described in claim 1, wherein said attachment mechanism further comprises:
a horizontal slot at least as wide as said first predetermined width and deeper than said first predetermined thickness, having an upper surface and substantially vertical first and second side walls, said horizontal slot being disposed in said lower surface of said surrounding case; at least one securing aperture, said securing aperture penetrating said surrounding case and said first vertical side wall at a point spaced from said upper surface by approximately said first predetermined thickness;
at least one mating receiving recess, said receiving recess disposed in said opposite second vertical side wall in alignment with said securing aperture;
at least one retaining rod, said retaining rod being sized and shaped to fit frictionally through said securing aperture and into said receiving recess; and
said flexible band being disposed in said horizontal slot, said retaining rod being inserted into said securing aperture, under said flexible band and into said mating receiving recess, thereby removably attaching said watch module to said flexible band.

10. The flexible band with clip-on watch, as described in claim 9, wherein said attachment mechanism further comprises:
a locking lip, said locking lip being disposed in a side edge of said surrounding case and slightly below an upper edge of said securing aperture; and
said locking lip bearing against said retaining rod as said rod is inserted into said securing aperture and thereby securing an end of said retaining rod and preventing said rod from moving backward out of said aperture and thus removably attaching said watch module to said flexible band.

11. The flexible band with clip-on watch, as described in claim 1, wherein said attachment mechanism further comprises:
an underband tray, said tray having first and second side edges, a horizontal slot at least as wide as said first predetermined width and at least as deep as said first predetermined thickness disposed between said side edges, either of a magnet and ferromagnetic material disposed between said first side edge and said slot;
said tray being hingedly attached adjacent said second side edge to said surrounding case; and
said surrounding case having either of a magnet and ferromagnetic material disposed in said lower surface to removably engage either of said magnet and said ferromagnetic material disposed in said tray, thereby removably attaching said watch module to said flexible band.

12. The flexible band with clip-on watch, as described in claim 1, wherein said attachment mechanism further comprises:
a horizontal slot at least as wide as said first predetermined width and substantially as deep as said first predetermined thickness, said horizontal slot being disposed in said lower surface of said surrounding case;
a spring clip, said spring clip having a first end and a second end being pivotally mounted at said first end to said lower surface of said surrounding case;
said surrounding case having a retaining recess, said recess being disposed in said lower surface adjacent to said horizontal slot and sized and shaped to removably receive said second end of said spring clip; and
said horizontal slot receiving said flexible band, said spring clip sliding pivotally over said band and removably engaging said retaining recess, thererby removably attaching said watch module to said flexible band.

13. The flexible band with clip-on watch, as described in claim 1, wherein said attachment mechanism further comprises:
a horizontal slot at least as wide as said first predetermined width and substantially as deep as said first predetermined thickness, said horizontal slot being disposed in said lower surface of said surrounding case;
at least one threaded hole, said threaded hole being disposed in an upper surface of said horizontal slot;
a screw, said screw having a mating thread for removably attaching to said threaded hole and a point for piercing said flexible band;
said screw penetrating said flexible band and removably engaging said threaded hole, thereby removably attaching said watch module to said flexible band.

14. The flexible band with clip-on watch, as described in claim 1, wherein said attachment mechanism further comprises:
at least one retaining arm, said retaining arm being formed of malleable material and descending from said surrounding case for a distance equal to at least a portion of said first predetermined width; and
said retaining arm being bendable over said flexible band and removably attaching said watch module to said flexible band.

15. The flexible band with clip-on watch, as described in claim 14, wherein said attachment mechanism further comprises a horizontal slot at least as wide as said first predetermined width and substantially as deep as said first predetermined thickness, said horizontal slot being disposed in said lower surface of said surrounding case.

16. The flexible band with clip-on watch, as described in claim 1, wherein said attachment mechanism further comprises:
a fixed retaining arm, said fixed arm descending from a side edge of said surrounding case and having a first inturned lip, said first lip being spaced from said lower surface of surrounding case by said first predetermined thickness;
a sliding retaining arm, said sliding arm descending from an opposite side edge of said surrounding case, having an upper slide member, and a second inturned lip, said second lip being spaced from said lower surface of surrounding case by said first predetermined thickness;
said upper slide member having a protrusion on either of an upper surface and a lower surface of said member and fitting slidably within a slot in said surrounding case adjacent said lower surface;
said slot having a detent on an interior wall of said slot, said detent removably receiving said protrusion; and
said first and second inturned lips removably engaging said flexible band, said protrusion on said slide member removably engaging saiddetent and thus removably attaching said watch module to said flexible band.

17. The flexible band with clip-on watch, as described in claim 1, wherein said attachment mechanism further comprises:
a receiving tray, said receiving tray having a horizontal slot at least as wide as said first predetermined width and approximately as deep as said first predetermined thickness, an upper surface, a lower surface and first and second side edges, said side edges being parallel to and extending outwardly from said horizontal slot;
first and second attachment notches, said notches being disposed at said first and second side edges, respectively, and extending from said upper surface to said lower surface of said tray and inwardly from said side edges;
first and second relief cuts, said relief cuts disposed at said lower surface of said tray and extending inwardly from said first and second attachment notches;
first and second snap fingers, said snap fingers extending downwardly from said surrounding case and having a securing ledge extending inwardly from lower ends of said fingers;
said first and second snap fingers being sized and shaped to fit slidably within said attachment notches and said securing ledges being sized and shaped to fit removably into said first and second relief cuts; and
said flexible band being disposed in said horizontal slot in said receiving tray, said tray being removably attached to said snap fingers and removably attaching said watch module to said flexible band.

18. The flexible band with clip-on watch, as described in claim 1, wherein said attachment mechanism further comprises:
a horizontal slot at least as wide as said first predetermined width and deeper than said first predetermined thickness, said horizontal slot being disposed in said lower surface of said surrounding case;
a retaining slot, said retaining slot being disposed about a perimeter of said surrounding case, slot having an upper edge and a lower edge, being spaced upwardly from said lower surface of said surrounding case, said upper edge being spaced downwardly from an upper surface of said horizontal slot by approximately said first predetermined thickness;
an elastic member, said elastic member being sized and shaped to fit closely between said upper edge and said lower edge of said retaining slot; and
said flexible band being disposed within said horizontal slot, said elastic member being disposed within said retaining slot and removably attaching said watch module to said flexible band.

19. The flexible band with clip-on watch, as described in claim 1, wherein said attachment mechanism further comprises:
a horizontal slot at least as wide as said first predetermined width and substantially as deep as said first predetermined thickness, said horizontal slot being disposed in said lower surface of said surrounding case, said slot having first and second parallel side edges;
first and second retaining brackets, said brackets extending outwardly from said first and second parallel side edges in opposite directions;
each of said retaining brackets terminating in a pair of pin fastening notches, said notches disposed on either side of said horizontal slot;
first and second securing pins, each of said pins having a shaft sized and shaped to fit frictionally within said pin fastening notches and first and second end caps, said ends caps being larger than said notches; and
said flexible band being disposed within said horizontal slot, said securing pins being disposed within said pin fastening notches and removably attaching said watch module to said flexible band.

20. The flexible band with clip-on watch, as described in claim 1, wherein said attachment mechanism further comprises:
a horizontal slot at least as wide as said first predetermined width and substantially as deep as said first predetermined thickness, said horizontal slot being disposed in said lower surface of said surrounding case, said slot having first and second parallel side edges;
first and second L-shaped clips, each of said L-shaped clips having a first end, a second end, first and second side edges and being hingedly attached to opposite side edges of said surrounding case;
said clips being sized and shaped to constrain said flexible band in said horizontal slot when folded below said case;
each of said clips having a raised retaining button;
each of said side edges of said surrounding case having a receiving detent, each of said detents being sized and shaped to removably retain one of said retaining buttons; and
said flexible band being disposed within said horizontal slot, said L-shaped clips being pivoted downwardly to constrain said band within said slot and said retaining buttons engaging said receiving detents to removably attach said watch module to said band.

21. The flexible band with clip-on watch, as described in claim 1, wherein said attachment mechanism further comprises:
first and second retaining brackets, each of said retaining brackets extending outwardly from said surrounding case in opposite directions parallel to said flexible band;
each of said retaining brackets having first and second parallel side plates, said side plates being spaced apart by at least said first predetermined width and terminating in an end bar connecting said side plates;
said surrounding case, each pair of side plates and each end bar defining an aperture at least twice as long as said first predetermined thickness;
first and second securing pins, each of said pins having a shaft at least as long as said first predetermined width and first and second end caps, said ends caps being larger than said shaft; and
said flexible band being disposed beneath said surrounding case and having loops extending upwardly through said apertures, said
securing pins disposed within said loops, said end within said horizontal slot, said securing pins being disposed within said pin fastening notches and said end caps securing said pins to said band, removably attaching said watch module to said band.

22. The flexible band with clip-on watch, as described in claim 21, further comprising a horizontal slot, said slot being at least as wide as said first predetermined width and substantially as deep as said first predetermined thickness, said horizontal slot being disposed in said lower surface of said surrounding case, said slot having first and second parallel side edges.

23. The flexible band with clip-on watch, as described in claim 1, wherein said attachment mechanism further comprises:
first and second retaining ledges, each of said retaining ledges extending outwardly from said surrounding case in opposite directions parallel to said flexible band;
a retaining clip, said clip being formed of resilient material, being sized and shaped to fit beneath said surrounding case and flexible band and having curved ends, said ends urging loops of said flexible band over said retaining ledges and inwardly toward said surrounding case, said curved ends extending upwardly past said ledges; and
said retaining clip removably attaching said watch module to said flexible band.

24. The flexible band with clip-on watch, as described in claim 23, further comprising a horizontal slot, said slot being at least as wide as said first predetermined width and substantially as deep as said first predetermined thickness, said horizontal slot being disposed in said lower surface of said surrounding case, said slot having first and second parallel side edges.

25. The flexible band with clip-on watch, as described in claim 1, wherein said attachment mechanism further comprises:
an attachment sleeve, said sleeve having a planar upper portion and a planar lower portion, each of said portions having an upper surface, a lower surface, first and second side edges, upper edges and lower edges;
said upper portion being attached to said lower surface of said surrounding case and hingedly attached at said first side edge to said first side edge of said lower portion;
at least one attachment means, said attachment means removably securing said upper portion to said lower portion at said second side edges;
said flexible band being removably secured between said upper portion and said lower portion, thereby removably attaching said watch module to said flexible band.

26. The flexible band with clip-on watch, as described in claim 25, wherein said attachment means is selected from the group consisting of: snap, button, hook and loop fastener and slot and turn button fastener.

27. The flexible band with clip-on watch, as described in claim 1, wherein said attachment mechanism further comprises:
first and second receiving bars, each of said bars being attached to opposite lower edges of said surrounding case and spaced outwardly from said case by a pair of support brackets;
a securing strap, said strap being formed of flexible material, having a first end, a second end, an upper surface and a lower surface, said upper surface having a hooking attachment means adjacent said first end, said lower surface having a loop attachment means adjacent said second end;
said flexible band being disposed beneath said lower surface of said surrounding case, said securing strap being looped over said receiving bars, under said flexible band, said second end being folded over said first end, said hooking attachment means removably engaging said loop attachment means and removably securing said watch module to said flexible band.

28. The flexible band with clip-on watch, as described in claim 27, further comprising a horizontal slot, said slot being at least as wide as said first predetermined width and substantially as deep as said first predetermined thickness, said horizontal slot being disposed in said lower surface of said surrounding case, said slot having first and second parallel side edges.

29. The flexible band with clip-on watch, as described in claim 1, wherein said attachment mechanism further comprises:
A subband fastener, said fastener being formed of resilient material, cylindrical, having a diameter less than an outer horizontal dimension of said watch module, a horizontal slot at least as wide as said first predetermined width, approximately as deep as said first predetermined thickness and a peripheral lip, said lip extending on either side of said slot;
said lower surface of said surrounding case having a recess, said recess being sized, shaped and shaped to receive said peripheral lip of said subband fastener; and
said flexible, continuous band being disposed within said horizontal slot and said subband fastener being fit frictionally into said recess, said watch module will be removably attached to said band.
